(19) United States
(12) Patent Application Publication
(10) Pub. No.: US 2026/0065628 A1
(43) Pub. Date: Mar. 5, 2026

(54) TECHNIQUES FOR DETECTING PIXEL-LEVEL ARTIFACTS

(71) Applicant: NETFLIX, INC., Los Gatos, CA (US)

(72) Inventor: Leo Furkan ISIKDOGAN, Santa Clara, CA (US)

(21) Appl. No.: 19/011,325

(22) Filed: Jan. 6, 2025

Related U.S. Application Data
(60) Provisional application No. 63/688,239, filed on Aug. 28, 2024.

(51) Int. Cl. G06V 10/44; G06V 20/70

(52) U.S. Cl. CPC G06V 10/44; G06V 20/70; G06V 2201/07

(57) ABSTRACT

Techniques for generating one or more artifact detections include generating, based on one or more video inputs, one or more downscaled features using a first convolution block, generating, based on the one or more downscaled features, one or more bottlenecked features using a second convolution block and a third convolution block, generating, based on the one or more downscaled features and the one or more bottlenecked features, one or more upscaled features using a fourth convolution block and a fifth convolution block, and generating, based on the one or more upscaled features, the one or more artifact detections.

### CROSS-REFERENCE TO RELATED APPLICATIONS

This application claims priority benefit of the United States Provisional patent application titled, “TECHNIQUES FOR DETECTING PIXEL-LEVEL ARTIFACTS,” filed on Aug. 28, 2024, and having Ser. No. 63/688,239. The subject matter of this related application is hereby incorporated herein by reference.

### BACKGROUND

### Technical Field

The embodiments of the present disclosure relate generally to computer science and machine learning, and more specifically, to techniques for detecting pixel-level artifacts.

### Description of the Related Art

Artifact detection systems are tools for identifying and localizing visual anomalies that occur at the pixel level and degrade the quality of digital images and videos. Artifacts refer to unintended distortions or errors that occur at the pixel level, such as hot pixels, dead pixels, compression artifacts, and/or the like. The unintended distortions, though often small, can have consequences in systems where visual accuracy is important. For example, in autonomous driving, a pixel-level artifact could be incorrectly detected as an obstacle, leading to unnecessary or unsafe vehicle maneuvers. In video production, undetected artifacts can propagate through editing, rendering, and distribution stages, resulting in noticeable visual defects that impact the viewer experience and require costly rework to correct. In medical imaging, artifacts could obscure important details, potentially leading to misdiagnosis or improper treatment. Artifact detection systems play an important role in ensuring the integrity of digital content across various industries, including but not limited to video production, broadcasting, surveillance, autonomous systems, and/or the like.

One conventional approach in artifact detection systems includes manual inspection, where quality control (QC) operators visually identify artifacts in images or videos. Historically, artifact detection has been a labor-intensive process, often performed manually in workflows, such as dailies review and post-production stages in video production. For example, operators in film and television production have to scrutinize each frame to detect hot pixels or compression artifacts, which, if missed, can propagate through editing and rendering processes, leading to costly rework. In medical imaging, radiologists and technicians could visually inspect scans to identify visual artifacts caused by sensor noise or imaging system errors, as the artifacts can obscure important diagnostic information.

One drawback of conventional artifact detection systems is that artifact detection systems are both time-consuming and prone to human error. As image and video resolutions increase, such as 4K and 8K formats, and the volume of visual data grows exponentially, manual inspection approaches become impractical and unsustainable. In video production, QC operators tasked with inspecting thousands of frames could miss subtle artifacts, such as hot pixels, compression errors, and/or the like, leading to visual defects that are discovered during later stages of production, resulting in costly rework. In medical imaging, relying on technicians to identify artifacts can delay diagnosis and risk overlooking subtle anomalies that could affect patient care.

As the foregoing illustrates, what is needed in the art are more effective techniques for pixel-level artifact detection.

### SUMMARY

One embodiment of the present disclosure sets forth a computer-implemented method for generating one or more artifact detections. The method include generating, based on one or more video inputs, one or more downscaled features using a first convolution block, generating, based on the one or more downscaled features, one or more bottlenecked features using a second convolution block and a third convolution block, generating, based on the one or more downscaled features and the one or more bottlenecked features, one or more upscaled features using a fourth convolution block and a fifth convolution block, and generating, based on the one or more upscaled features, the one or more artifact detections.

Other embodiments of the present disclosure include, without limitation, one or more computer-readable media including instructions for performing one or more aspects of the disclosed techniques as well as one or more computing systems for performing one or more aspects of the disclosed techniques.

At least one technical advantage of the disclosed techniques relative to prior art is that the disclosed techniques automate the detection of artifacts in video and image data, reducing the reliance on manual inspection. Unlike conventional approaches that depend on QC operators or technicians to visually inspect data, the disclosed techniques use a trained machine learning model capable of detecting pixel-level artifacts, such as hot pixels, compression errors, and/or the like. Another technical advantage of the disclosed techniques is that the disclosed techniques are scalable, enabling artifact detection in exponentially growing video and/or image datasets without increasing processing time or introducing delays. These technical advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a network infrastructure used to distribute content to content servers and endpoint devices, according to various embodiments of the present disclosure;

FIG. 2 is a block diagram of a content server that can be implemented in conjunction with the network infrastructure of FIG. 1, according to various embodiments of the present disclosure;

FIG. 3 is a block diagram of a control server that can be implemented in conjunction with the network infrastructure of FIG. 1, according to various embodiments of the present disclosure; and

FIG. 4 is a block diagram of an endpoint device that can be implemented in conjunction with the network infrastructure of FIG. 1, according to various embodiments of the present disclosure;

FIG. 5 is a block diagram of a computer-based system according to various embodiments;

FIG. 6 is a more detailed illustration of the synthetic artifact data generation module of FIG. 5, according to various embodiments;

FIG. 7A is a more detailed illustration of the model trainer of FIG. 5 training artifact detection model, according to various embodiments;

FIG. 7B is a more detailed illustration of the refinement data selection module of FIG. 5, according to various embodiments;

FIG. 7C is a more detailed illustration of the model trainer of FIG. 5 re-training artifact detection model, according to various embodiments;

FIG. 8 is a more detailed illustration of the artifact detection application of FIG. 5, according to various embodiments;

FIG. 9A is a more detailed illustration of the artifact detection model of FIG. 5, according to various embodiments;

FIG. 9B is a more detailed illustration of the downscaling module of the artifact detection model of FIG. 9A, according to various embodiments;

FIG. 9C is a more detailed illustration of the bottleneck module of the artifact detection model of FIG. 9A, according to various embodiments;

FIG. 9D is a more detailed illustration of the upscaling module of the artifact detection model of FIG. 9A, according to various embodiments;

FIG. 9E is a more detailed illustration of the convolution block of FIGS. 9B-9D, according to various embodiments;

FIG. 10 sets forth a flow diagram of method steps for generating synthetic artifact data, according to various embodiments;

FIG. 11 sets forth a flow diagram of method steps for training an artifact detection model, according to various embodiments;

FIG. 12 sets forth a flow diagram of method steps for detecting artifacts, according to various embodiments; and

FIG. 13 sets forth a flow diagram of method steps for detecting artifacts based on processed video frames, according to various embodiments.

### DETAILED DESCRIPTION

In the following description, numerous specific details are set forth to provide a more thorough understanding of the embodiments of the present invention. However, it will be apparent to one of skill in the art that the embodiments of the present invention may be practiced without one or more of these specific details.

### System Overview

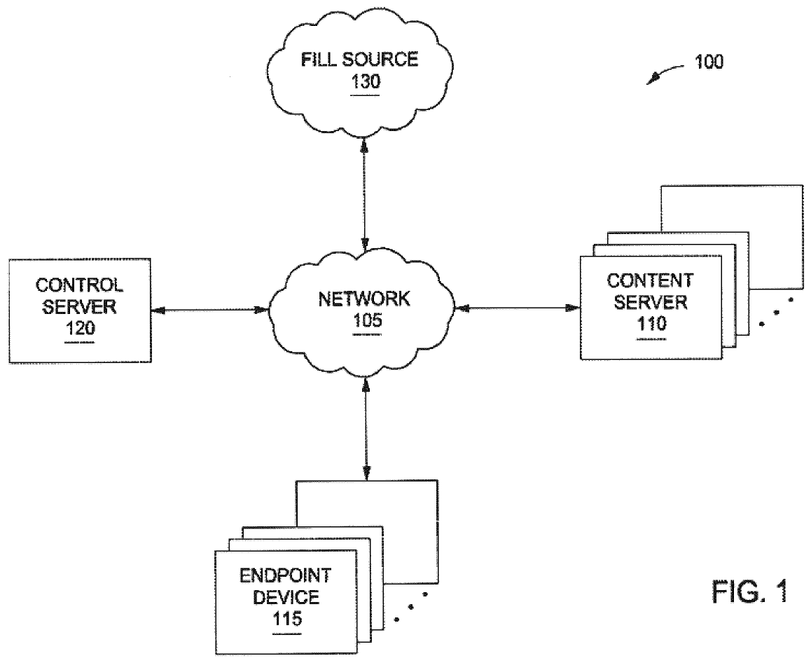

FIG. 1 illustrates a network infrastructure 100 used to distribute content to content servers 110 and endpoint devices 115, according to various embodiments of the invention. As shown, the network infrastructure 100 includes content servers 110, control server 120, and endpoint devices 115, each of which are connected via a network 105.

Each endpoint device 115 communicates with one or more content servers 110 (also referred to as “caches” or “nodes”) via the network 105 to download content, such as textual data, graphical data, audio data, video data, and other types of data. The downloadable content, also referred to herein as a “file,” is then presented to a user of one or more endpoint devices 115. In various embodiments, the endpoint devices 115 may include computer systems, set top boxes, mobile computer, smartphones, tablets, console and handheld video game systems, digital video recorders (DVRs), DVD players, connected digital TVs, dedicated media streaming devices, (e.g., the Roku® set-top box), and/or any other technically feasible computing platform that has network connectivity and is capable of presenting content, such as text, images, video, and/or audio content, to a user.

Each content server 110 may include a web-server, database, and server application 217 configured to communicate with the control server 120 to determine the location and availability of various files that are tracked and managed by the control server 120. Each content server 110 may further communicate with a fill source 130 and one or more other content servers 110 in order “fill” each content server 110 with copies of various files. In addition, content servers 110 may respond to requests for files received from endpoint devices 115. The files may then be distributed from the content server 110 or via a broader content distribution network. In some embodiments, the content servers 110 enable users to authenticate (e.g., using a username and password) in order to access files stored on the content servers 110. Although only a single control server 120 is shown in FIG. 1, in various embodiments multiple control servers 120 may be implemented to track and manage files.

In various embodiments, the fill source 130 may include an online storage service (e.g., Amazon® Simple Storage Service, Google® Cloud Storage, etc.) in which a catalog of files, including thousands or millions of files, is stored and accessed in order to fill the content servers 110. Although only a single fill source 130 is shown in FIG. 1, in various embodiments multiple fill sources 130 may be implemented to service requests for files. Further, as is well-understood, any cloud-based services can be included in the architecture of FIG. 1 beyond fill source 130 to the extent desired or necessary.

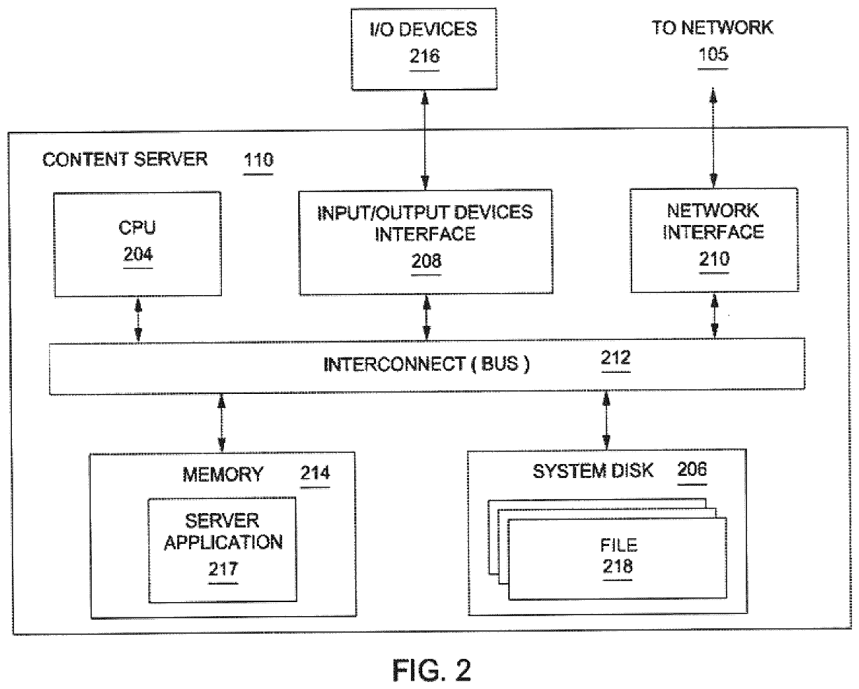

FIG. 2 is a block diagram of a content server 110 that may be implemented in conjunction with the network infrastructure 100 of FIG. 1, according to various embodiments of the present invention. As shown, the content server 110 includes, without limitation, a central processing unit (CPU) 204, a system disk 206, an input/output (I/O) devices interface 208, a network interface 210, an interconnect 212, and a system memory 214.

The CPU 204 is configured to retrieve and execute programming instructions, such as server application 217, stored in the system memory 214. Similarly, the CPU 204 is configured to store application data (e.g., software libraries) and retrieve application data from the system memory 214. The interconnect 212 is configured to facilitate transmission of data, such as programming instructions and application data, between the CPU 204, the system disk 206, I/O devices interface 208, the network interface 210, and the system memory 214. The I/O devices interface 208 is configured to receive input data from I/O devices 216 and transmit the input data to the CPU 204 via the interconnect 212. For example, I/O devices 216 may include one or more buttons, a keyboard, a mouse, and/or other input devices. The I/O devices interface 208 is further configured to receive output data from the CPU 204 via the interconnect 212 and transmit the output data to the I/O devices 216.

The system disk 206 may include one or more hard disk drives, solid state storage devices, or similar storage devices. The system disk 206 is configured to store non-volatile data such as files 218 (e.g., audio files, video files, subtitles, application files, software libraries, etc.). The files 218 can then be retrieved by one or more endpoint devices 115 via the network 105. In some embodiments, the network interface 210 is configured to operate in compliance with the Ethernet standard.

The system memory 214 includes a server application 217 configured to service requests for files 218 received from endpoint device 115 and other content servers 110. When the server application 217 receives a request for a file 218, the server application 217 retrieves the corresponding file 218 from the system disk 206 and transmits the file 218 to an endpoint device 115 or a content server 110 via the network 105.

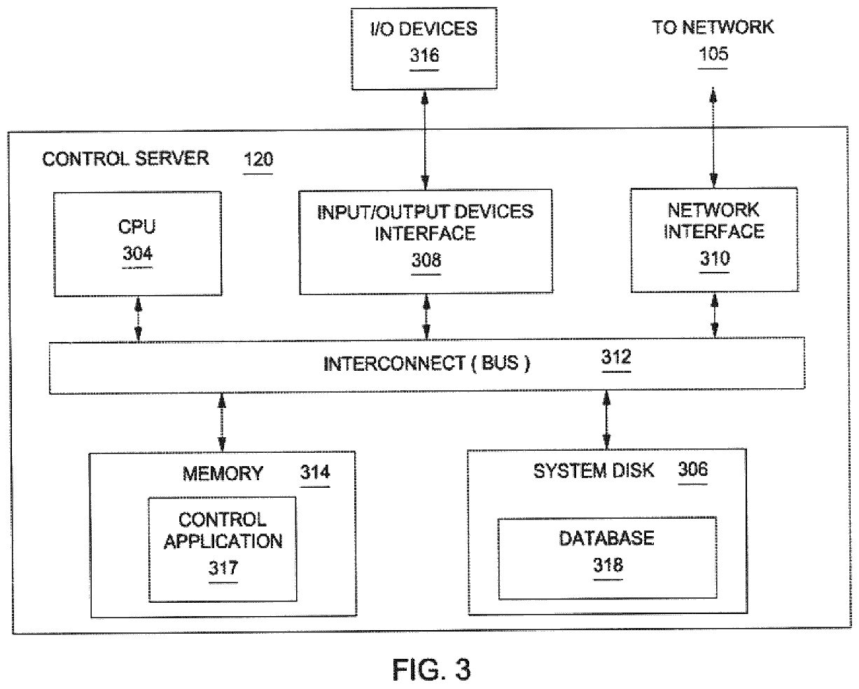

FIG. 3 is a block diagram of a control server 120 that may be implemented in conjunction with the network infrastructure 100 of FIG. 1, according to various embodiments of the present invention. As shown, the control server 120 includes, without limitation, a central processing unit (CPU) 304, a system disk 306, an input/output (I/O) devices interface 308, a network interface 310, an interconnect 312, and a system memory 314.

The CPU 304 is configured to retrieve and execute programming instructions, such as control application 317, stored in the system memory 314. Similarly, the CPU 304 is configured to store application data (e.g., software libraries) and retrieve application data from the system memory 314 and a database 318 stored in the system disk 306. The interconnect 312 is configured to facilitate transmission of data between the CPU 304, the system disk 306, I/O devices interface 308, the network interface 310, and the system memory 314. The I/O devices interface 308 is configured to transmit input data and output data between the I/O devices 316 and the CPU 304 via the interconnect 312. The system disk 306 may include one or more hard disk drives, solid state storage devices, and the like. The system disk 206 is configured to store a database 318 of information associated with the content servers 110, the fill source(s) 130, and the files 218.

The system memory 314 includes a control application 317 configured to access information stored in the database 318 and process the information to determine the manner in which specific files 218 will be replicated across content servers 110 included in the network infrastructure 100. The control application 317 may further be configured to receive and analyze performance characteristics associated with one or more of the content servers 110 and/or endpoint devices 115.

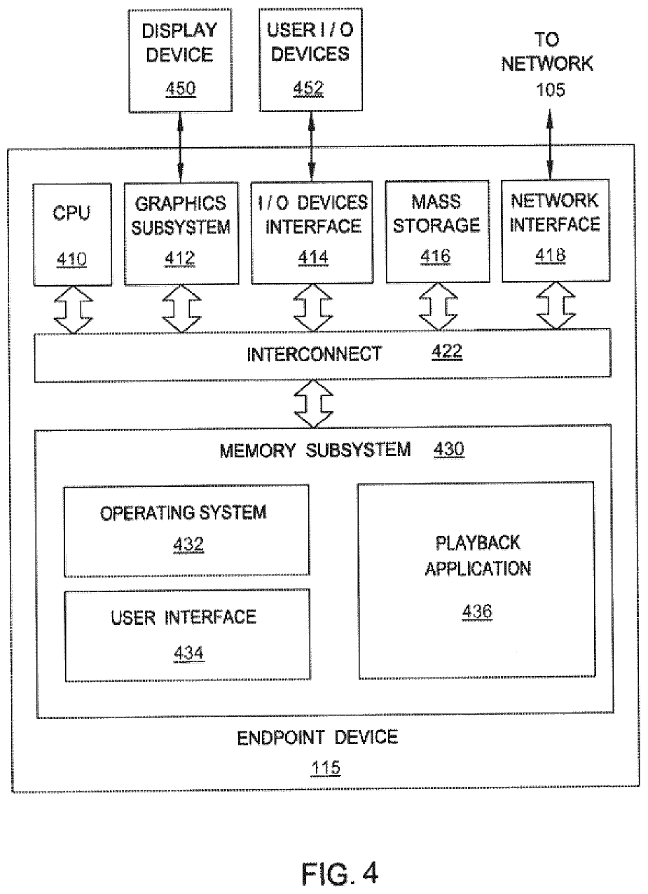

FIG. 4 is a block diagram of an endpoint device 115 that may be implemented in conjunction with the network infrastructure 100 of FIG. 1, according to various embodiments of the present invention. As shown, the endpoint device 115 may include, without limitation, a CPU 410, a graphics subsystem 412, an I/O device interface 414, a mass storage unit 416, a network interface 418, an interconnect 422, and a memory subsystem 430.

In some embodiments, the CPU 410 is configured to retrieve and execute programming instructions stored in the memory subsystem 430. Similarly, the CPU 410 is configured to store and retrieve application data (e.g., software libraries) residing in the memory subsystem 430. The interconnect 422 is configured to facilitate transmission of data, such as programming instructions and application data, between the CPU 410, graphics subsystem 412, I/O devices interface 414, mass storage unit 416, network interface 418, and memory subsystem 430.

In some embodiments, the graphics subsystem 412 is configured to generate frames of video data and transmit the frames of video data to display device 450. In some embodiments, the graphics subsystem 412 may be integrated into an integrated circuit, along with the CPU 410. The display device 450 may comprise any technically feasible means for generating an image for display. For example, the display device 450 may be fabricated using liquid crystal display (LCD) technology, cathode-ray technology, and light-emitting diode (LED) display technology. An input/output (I/O) device interface 414 is configured to receive input data from user I/O devices 452 and transmit the input data to the CPU 410 via the interconnect 422. For example, user I/O devices 452 may comprise one of more buttons, a keyboard, and a mouse or other pointing device. The I/O device interface 414 also includes an audio output unit configured to generate an electrical audio output signal. User I/O devices 452 includes a speaker configured to generate an acoustic output in response to the electrical audio output signal. In alternative embodiments, the display device 450 may include the speaker. A television is an example of a device known in the art that can display video frames and generate an acoustic output.

A mass storage unit 416, such as a hard disk drive or flash memory storage drive, is configured to store non-volatile data. A network interface 418 is configured to transmit and receive packets of data via the network 105. In some embodiments, the network interface 418 is configured to communicate using the well-known Ethernet standard. The network interface 418 is coupled to the CPU 410 via the interconnect 422.

In some embodiments, the memory subsystem 430 includes programming instructions and application data that comprise an operating system 432, a user interface 434, and a playback application 436. The operating system 432 performs system management functions such as managing hardware devices including the network interface 418, mass storage unit 416, I/O device interface 414, and graphics subsystem 412. The operating system 432 also provides process and memory management models for the user interface 434 and the playback application 436. The user interface 434, such as a window and object metaphor, provides a mechanism for user interaction with endpoint device 108. Persons skilled in the art will recognize the various operating systems and user interfaces that are well-known in the art and suitable for incorporation into the endpoint device 108.

In some embodiments, the playback application 436 is configured to request and receive content from the content server 110 via the network interface 418. Further, the playback application 436 is configured to interpret the content and present the content via display device 450 and/or user I/O devices 452.

### Artifact Detection Using An Artifact Detection Model

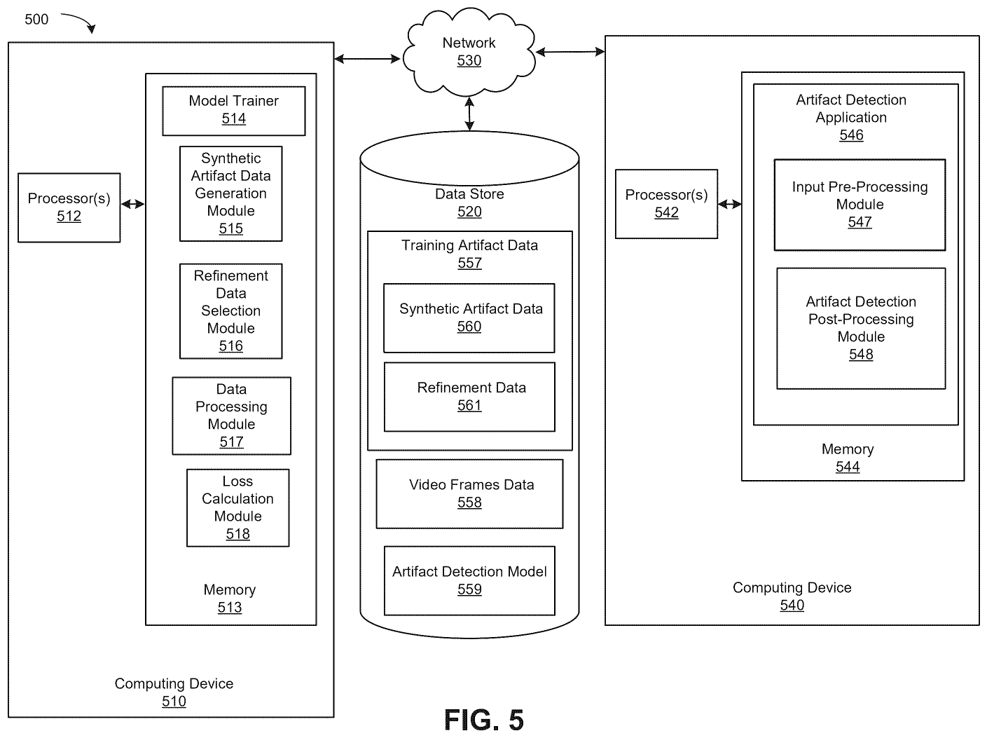

FIG. 5 is a block diagram of a computer-based system 500 according to various embodiments. As shown, computer-based system 500 includes, without limitation, computing devices 510 and 540, a data store 520, and a network 530. Computing device 510 includes, without limitation, one or more processors 512 and memory 513. Memory 513 includes, without limitation, a model trainer 514, synthetic artifact data generation module 515, refinement data selection module 516, data processing module 517, and loss calculation module 518. Data store 520 includes, without limitation, training artifact data 557, video frames data 558, and an artifact detection model 559. Training artifact data 557 includes, without limitation, synthetic artifact data 560 and refinement data 561. Computing device 540 includes, without limitation, one or more processors 542 and memory 544. Memory 544 includes, without limitation, an artifact detection application 546. Artifact detection application 546 includes, without limitation, an input pre-processing module 547 and an artifact detection post-processing module 548. And although the embodiments of FIG. 5 are described in the context of artifact detection systems, it is understood that the disclosed techniques are also applicable to other areas of machine learning, such as image classification models, object detection systems, video quality analysis tools, and medical imaging systems and/or the like.

Computing device 510 shown herein is for illustrative purposes only, and variations and modifications in the design and arrangement of computing device 510, without departing from the scope of the present disclosure. For example, the number of processors 512, the number of and/or type of memories 513, and/or the number of applications and or data stored in memory 513 can be modified as desired. In some embodiments, any combination of processor(s) 512 and/or memory 513 can be included in and/or replaced with any type of virtual computing system, distributed computing system, and/or cloud computing environment, such as a public, private, or a hybrid cloud system.

Each of processor(s) 512 can be any suitable processor, such as a CPU, a GPU, an ASIC, an FPGA, a DSP, a multicore processor, and/or any other type of processing unit, or a combination of two or more of a same type and/or different types of processing units, such as a SoC, or a CPU configured to operate in conjunction with a GPU. In general, processors 512 can be any technically feasible hardware unit capable of processing data and/or executing software applications. During operation, processor(s) 512 can receive user input from input devices (not shown), such as a keyboard or a mouse.

Memory 513 of computing device 510 stores content, such as software applications and data, for use by processor(s) 512. As shown, memory 513 includes, without limitation, model trainer 514, synthetic artifact data generation module 515, refinement data selection module 516, data processing module 517, and loss calculation module 518. Memory 513 can be any type of memory capable of storing data and software applications, such as a random-access memory (RAM), a read-only memory (ROM), an erasable programmable read-only memory (EPROM or Flash ROM), or any suitable combination of the foregoing. In some embodiments, additional storage (not shown) can supplement or replace memory 513. The storage can include any number and type of external memories that are accessible to processor(s) 512. For example, and without limitation, the storage can include a Secure Digital Card, an external Flash memory, a portable CD-ROM, an optical storage device, a magnetic storage device, and/or any suitable combination of the foregoing.

Model Trainer 514 is stored in memory 513 and is executed by processor(s) 512. Model trainer 514 uses training artifact data 557 to train artifact detection model 559. Training artifact data 557 includes, without limitation, synthetic artifact data 560 and refinement data 561. Synthetic artifact data 560 includes video frames or images superimposed with artifacts that are synthetically generated based on predetermined artifact parameters and metrics, such as brightness values, edge values, and movement values. For example, in video editing, synthetic artifact data 560 could include video frames or images with artifact labels for symmetrical artifacts, such as hot pixels caused by camera sensor errors, curvilinear artifacts, such as streaks resembling lens flare effects, compression artifacts that occur during video encoding, and/or the like. In some examples, artifacts are synthetically generated and superimposed in controlled scenarios, such as static scenes with uniform backgrounds or areas of high contrast, to mimic real-world challenges in video editing workflows. In medical imaging, synthetic artifact data 560 could include noise patterns resembling dead pixels in X-ray images, streaking artifacts in CT scans, or MRI-specific distortions such as ghosting or ringing effects.

Refinement data 561 includes video frames or images from real-world video or image datasets such as video frames data 558, augmented with various artifact labels such as false positive labels and/or the like. In some embodiments, artifact detection model 559 trained on synthetic artifact data 560 is used to generate artifact labels for frames from video frames data 558. Video frames data 558 includes various real-world video frames or images, such as dailies rolls, footage captured from cameras during production workflows, medical imaging scans, and/or the like. The generated artifact labels for frames from video frames data 558 are compared to ground truth values for the frames. Frames for which the generated artifact label incorrectly identifies an artifact when an artifact is not present are categorized as false positive training examples, which are added to refinement data 561. For example, in video editing, false positive labels could include reflections, specular highlights, or bokeh effects (e.g., a photography technique that intentionally blurs the background of an image or video frame to draw attention to the subject) were misclassified as artifacts. In medical imaging, false positive labels could include misclassified natural anatomical structures, such as blood vessels, or physiological variations, such as small calcifications, and/or the like.

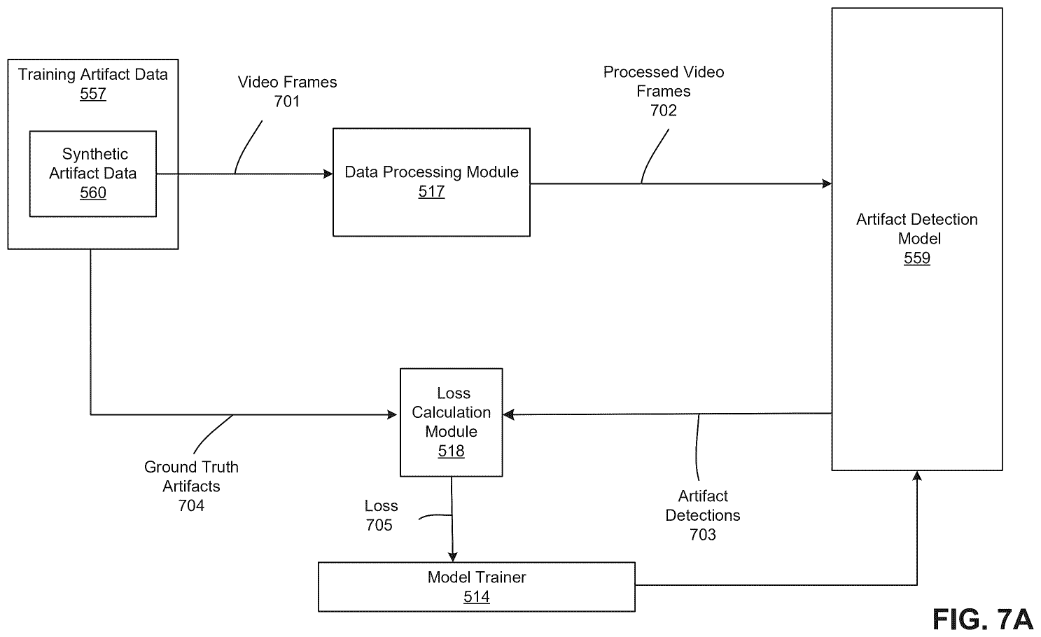

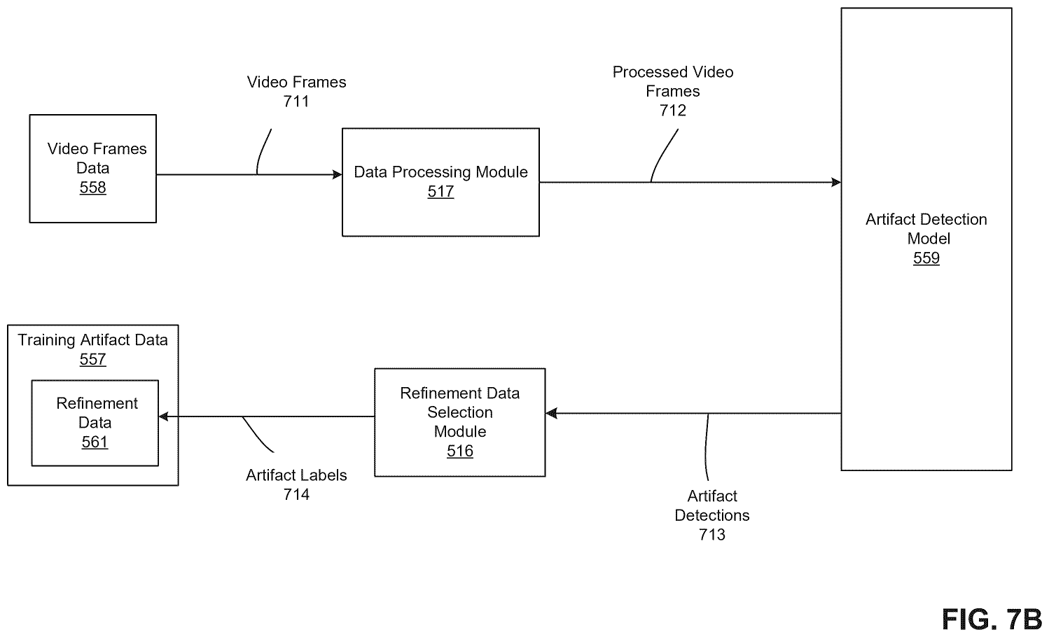

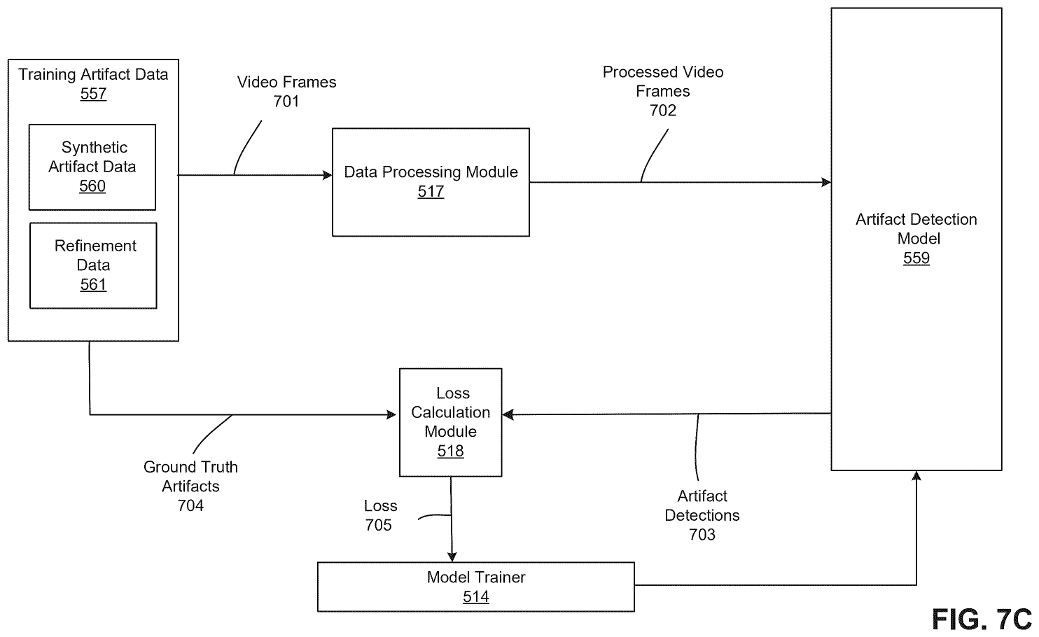

In various embodiments, model trainer 514 initially trains artifact detection model 559 using synthetic artifact data 560. Model trainer 514 is then used to re-train artifact detection model 559 using refinement data 561. Model trainer 514 can employ any suitable techniques to train artifact detection model 559 including supervised learning, semi-supervised learning, or iterative training processes. In iterative training processes, model trainer 514 uses staged optimization to train artifact detection model 559, where model trainer 514 alternates between training artifact detection model 559 using synthetic artifact data 560 and refinement data 561, progressively reducing false positives while retaining accuracy to detect true artifacts. In some embodiments, model trainer 514 uses an Exponential Moving Average (EMA) for the parameters (e.g., weights) of artifact detection model 559 during training. EMA maintains a smoothed version of parameters of artifact detection model 559 by averaging weights over training iterations, which stabilizes training and often results in improved artifact detection performance during inference. EMA ensures that artifact detections generated by artifact detection model 559 are less affected by noisy weight updates, contributing to more consistent artifact detection results. Once artifact detection model 559 is re-trained, model trainer 514 stores artifact detection model 559 in data store 520 for access by other computing devices, such as computing device 540. Model trainer 514 is described in more detail in conjunction with FIGS. 7A and 7C.

Synthetic artifact data generation module 515 processes video frames data 558 to generate synthetic artifact data 560. In various embodiments, synthetic artifact data generation module 515 analyzes one or more video frames included in video frames data 558 to determine an artifact position distribution based on various metrics, such as brightness values, edge values, movement values, and/or the like. The metrics help identify regions in the video frames where synthetic artifacts can be placed realistically, such as low-motion areas, darker regions, or edges where artifacts are more visually pronounced. For example, brightness values can guide the placement of artifacts in low-light regions, edge values can help align artifacts with high-contrast boundaries, and movement values can ensure artifacts are generated in static regions to maintain realism. Concurrently or sequentially, synthetic artifact data generation module 515 generates one or more synthetic artifacts, such as symmetrical artifacts, curvilinear artifacts, and/or the like, based on artifact parameters. Artifact parameters include attributes such as the type, shape, size, intensity, orientation, color, and/or the like, of the artifacts. For example, synthetic artifact data generation module 515 can use artifact parameters to generate symmetrical artifacts, such as hot pixels with specific intensity and color values or curvilinear artifacts resembling streaks with defined orientation and length. In various embodiments, synthetic artifact data generation module 515 generates synthetic artifact data 560 based on video frames from video frames data 558, one or more synthetic artifacts, and artifact position distribution. In some embodiments, synthetic artifact data generation module 515 superimposes synthetic artifacts onto the video frames at positions determined by the artifact position distribution. In various embodiments, the superimposition process includes blending the synthetic artifacts with the underlying video frames while preserving the natural characteristics of the video frames. For example, a bright pixel can be added to a static, dark region of the video frame to mimic a sensor defect, or a streak-like artifact can be overlaid along a smooth gradient to simulate motion blur or lens scratches. The resulting synthetic artifact data 560 includes video frames with superimposed artifacts, along with precise ground truth annotations for the artifact locations and properties, which can be used by model trainer 514 to train artifact detection model 559.

Refinement data selection module 516 processes one or more artifact detections to generate one or more artifact labels. Artifact detections are outputs generated by artifact detection model 559, identifying regions in video frames or images where artifact detection model 559 predicts the presence of an artifact. Artifact detections include coordinates, bounding boxes, heatmaps, and/or the like, indicating potential artifact locations and associated confidence scores. For example, in video editing, artifact detections can identify a bright pixel in a static scene as a hot pixel or detect streak-like patterns resembling motion blur. In medical imaging, artifact detections can highlight regions with potential noise, streaking artifacts in CT scans, or ghosting in MRI images. Artifact labels are annotations generated by refinement data selection module 516 based on artifact detections that confirm or correct the predictions made by artifact detection model 559. Artifact labels include both true artifact labels, which indicate correctly identified artifacts, and false positive labels, which mark detections that were incorrectly classified as artifacts. For example, an artifact detection labeled as a false positive in a video frame could indicate that a reflection or specular highlight was wrongly flagged as an artifact. In medical imaging, a false positive label could signify that an anatomical structure, such as a blood vessel, was misclassified as noise or an artifact. By selecting frames with false positive labels and storing the labeled frames in refinement data 561, refinement data selection module 516 ensures that refinement data 561 not only includes correct detections but also includes model detection errors, enabling model trainer 514 to train artifact detection model 559 iteratively to learn from false detection. Refinement data selection module 516 selects false positive labels through various approaches. In some embodiments, refinement data selection module 516 compares artifact detections against a corpus of frames labeled with ground truth artifacts. Refinement data selection module 516 identifies discrepancies between the artifact detections and the ground truth artifacts, automatically flagging regions where artifacts were incorrectly detected. For example, if a ground truth dataset in video editing specifies no artifacts in a particular frame, but artifact detection model 559 flags a reflection as a hot pixel, refinement data selection module 516 selects a false positive label for that artifact detection. In medical imaging, when the ground truth artifacts confirms no streaking artifacts in a CT scan, any artifact detection by artifact detection model 559 in that region is labeled as a false positive. In some embodiments, refinement data selection module 516 uses manual reviews involving human operators examining the artifact detections to verify whether the identified regions truly correspond to artifacts. For example, in video editing, a human operator could review a bright spot flagged as a hot pixel and determine the bright spot is instead a reflection, assigning a false positive label. In at least one embodiment, refinement data selection module 516 uses automated approaches to select false positive labels. One automated approach includes analyzing the confidence scores associated with artifact detections, where artifact detections with low confidence scores are flagged as potential false positives. For example, in medical imaging, a low-confidence detection of a streaking artifact in a CT scan can be automatically labeled as a false positive. Another automated approach includes ensemble-based consensus, where artifact detections from multiple artifact detection models are compared, and inconsistencies are flagged as likely false positives. For example, in video processing, a specular highlight misclassified as an artifact by a single artifact detection model can be automatically identified as a false positive. Yet another automated approach includes temporal or spatial consistency checks, which assess artifact detections across consecutive video frames or spatially related regions. Artifact detections that do not persist over time or appear isolated in static video frames can be flagged as false positives, such as transient noise patterns in video frames or singularly detected pixels without neighboring anomalies. Refinement data selection module 516 is described in more detail in conjunction with FIG. 7B.

Data processing module 517 generates processed video frames based on one or more video frames. In various embodiments, data processing module 517 processes the video frames to ensure compatibility with the artifact detection model 559. In some embodiments, data processing module resizes the video frames to match the input dimensions expected by artifact detection model 559. In various embodiments, data processing module 517 normalizes pixel values in the video frames to a predefined range (e.g., 0 to 1 or −1 to 1). For example, a video frame with a resolution of 1920×1080 can be resized to 224×224 for compatibility with artifact detection model 559. In various embodiments, data processing module 517 carries out additional processing of video frames by organizing the video frames into temporal sequences whenever artifact detection model 559 uses spatiotemporal features. For example, if artifact detection model 559 processes a sliding window of five consecutive video frames to capture motion-related artifacts, data processing module 517 ensures the video frames are properly aligned and formatted for input. Noise reduction techniques or edge-enhancement filters are also applied to emphasize features relevant to artifact detection, such as hot pixels, streaks, and/or the like.

Loss calculation module 518 generates loss based on one or more artifact detections and one or more ground truth artifacts. Loss quantifies the difference between the artifact detection generated by artifact detection model 559 and the actual artifact annotations included in ground truth artifacts, guiding the optimization of the model during training. For example, loss calculation module 518 can compute a pixel-wise binary cross-entropy loss for artifact detection, where each pixel in the output heatmap included in artifact detections is compared against the corresponding ground truth label to determine whether the output heatmap correctly identifies an artifact. In some embodiments, loss calculation module 518 uses a combination of loss. For example, loss calculation module 518 can combine cross-entropy loss with the Dice coefficient loss, which measures the overlap between predicted artifact regions and ground truth regions, to ensure accurate localization of artifacts. In video editing, loss calculation module 518 can evaluate how well artifact detection model 559 detects synthetic hot pixels in a dark background by comparing the predicted artifact positions with annotated positions included in ground truth artifacts. In medical imaging, loss calculation module 518 can assess the accuracy of artifact detections such as streaks or noise patterns in CT scans by comparing predicted artifact masks included in artifact detections with ground truth masks included in ground truth artifacts. In some embodiments, loss calculation module 518 weighs certain types of discrepancies between artifact detections and ground truth artifacts more heavily, such as penalizing false positives in regions where no artifacts are expected or false negatives in areas with known artifacts.

Data store 520 can include any storage device or devices, such as fixed disc drive(s), flash drive(s), optical storage, network attached storage (NAS), and/or a storage area-network (SAN). Although shown as accessible over network 530, in some embodiments computing device 510 can include data store 520. As shown, data store 520 is storing synthetic artifact data 560, video frames data 558, and artifact detection model 559.

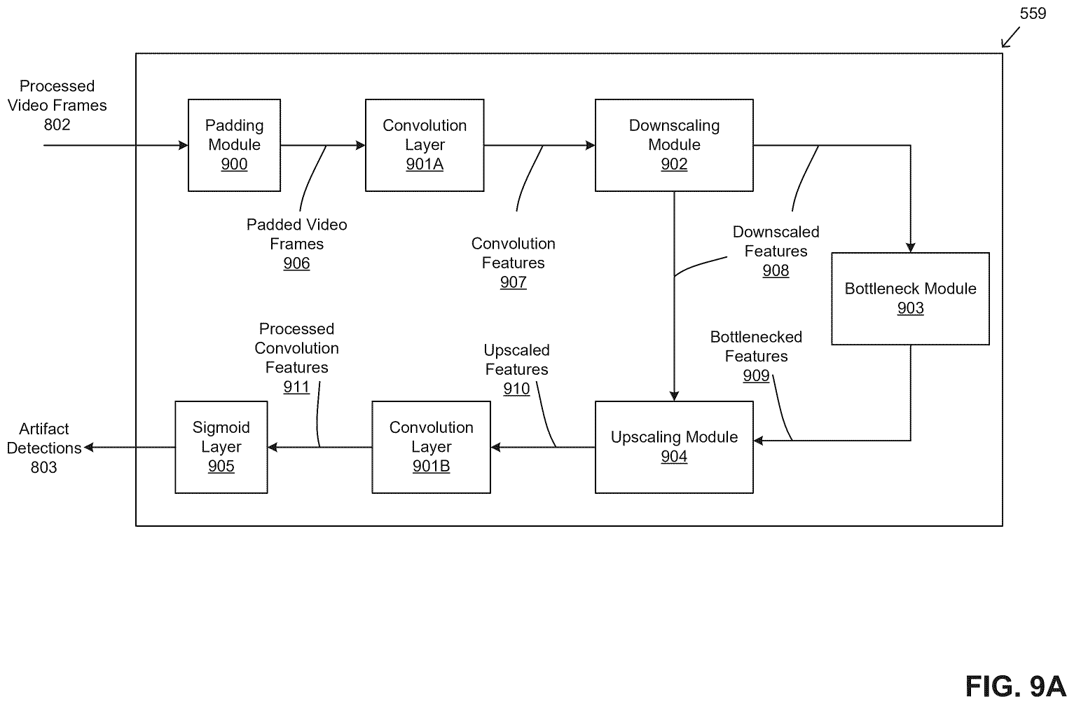

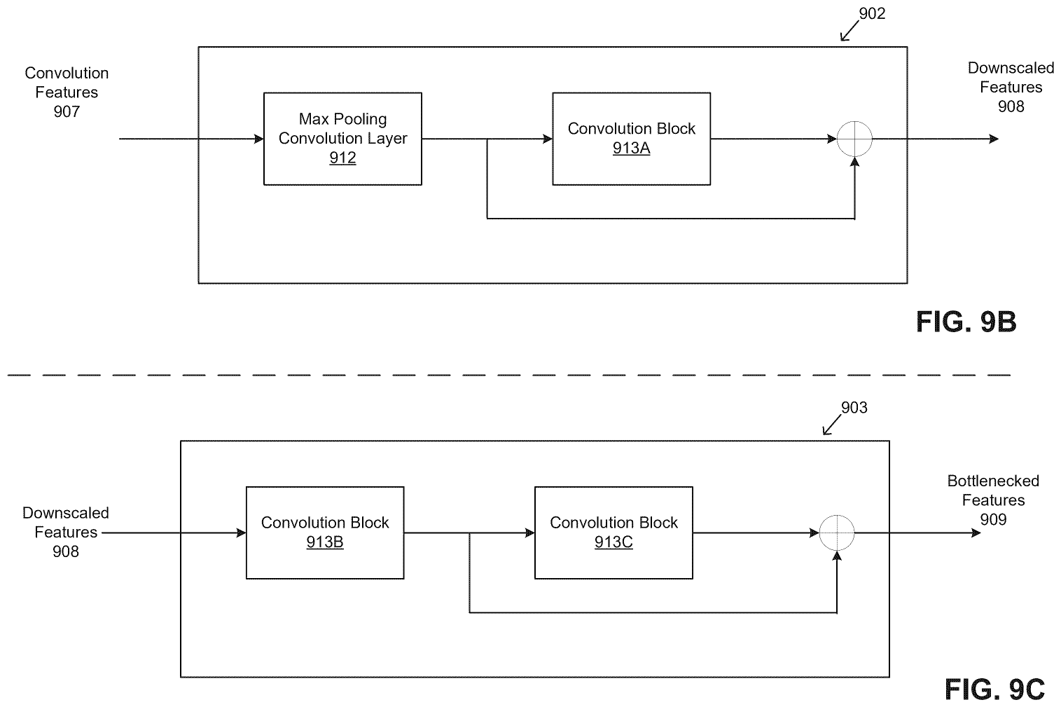

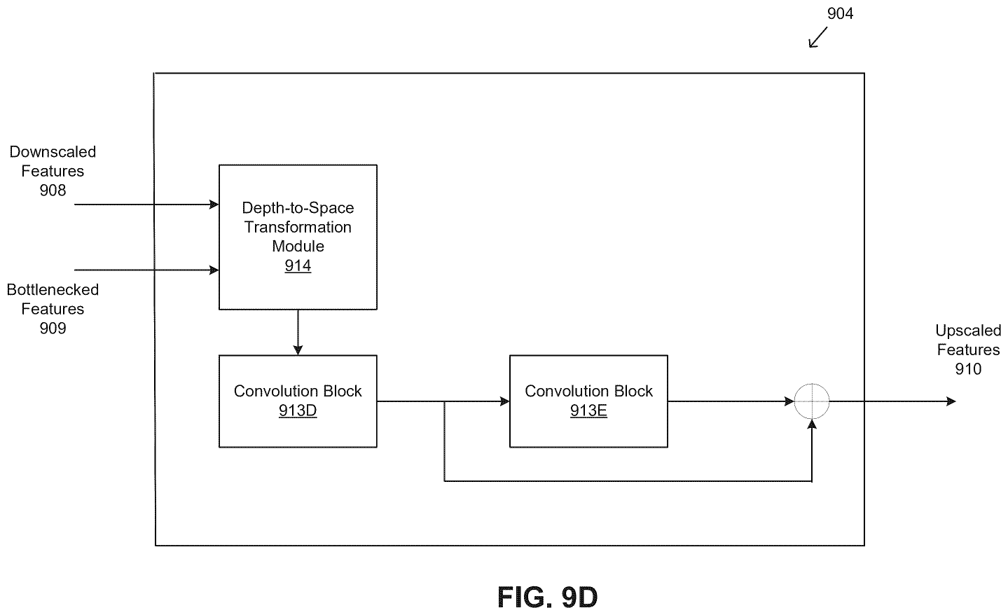

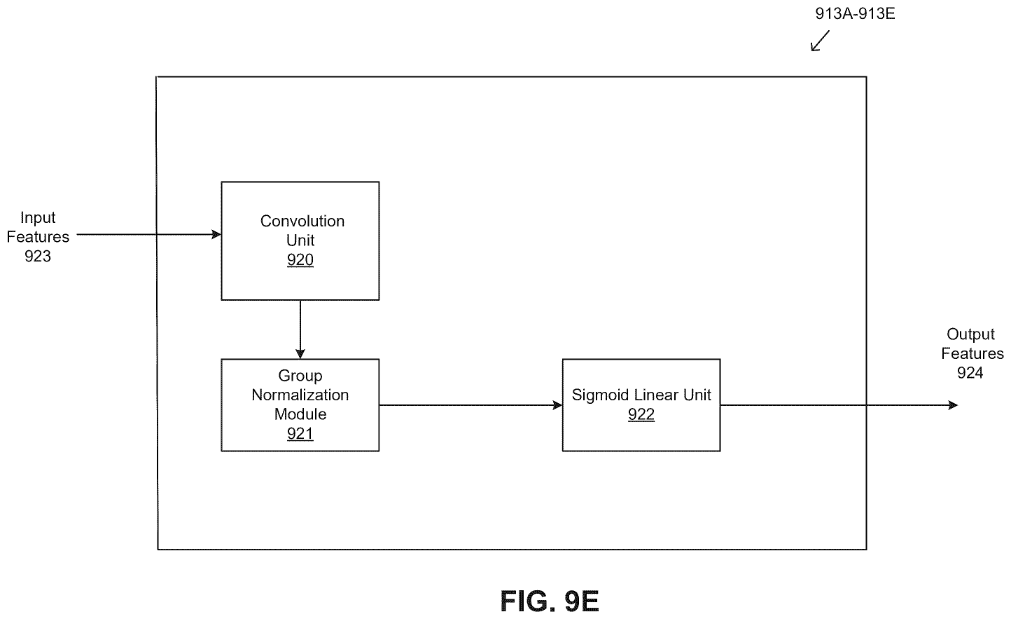

Artifact detection model 559 generates artifact detections based on one or more processed video frames. In various embodiments, artifact detection model 559 processes one or more processed frames using various operations, such as convolutions, maxpooling, downscaling, upscaling, bottlenecking, and/or the like, to extract and analyze spatial and visual features associated with artifacts. In various embodiments, artifact detection model 559 is a machine learning model, such as a neural network, which includes a plurality of layers. For example, artifact detection model 559 can identify low-level features, such edges or brightness variations, in the initial layers, while deeper layers of the model analyze higher-level patterns indicative of specific artifact types. In some embodiments, artifact detection model 559 uses temporal information whenever the one or more processed video frames include consecutive video frames, to detect motion-related artifacts or distinguish transient noise from persistent anomalies (e.g., artifacts). In at least one embodiment, artifact detection model 559 includes one or more convolution blocks. In some embodiments, each convolution block includes a convolution unit for feature extraction, a group normalization module to normalize feature maps and improve training stability, and a sigmoid linear unit (SiLU) activation function to introduce non-linearity, enhancing the ability of artifact detection model 559 to capture nonlinear patterns associated with artifacts. In some embodiments, artifact detection model 559 includes a padding module that processes the processed video frames and generates padded video frames to ensure compatibility with the architecture of artifact detection model 559, especially when the frame dimensions are not evenly divisible by the required input size of the convolutional layers included in artifact detection model 559. For example, for video frames with a height of 1080 pixels, which is not divisible by 16, the padding module can add sufficient padding to align the video frame dimensions with the requirements of artifact detection model 559. Artifact detection model 559 is described in more detail in conjunction with FIG. 9A-9E.

Network 530 can be a wide area network (WAN), such as the Internet, a local area network (LAN), a cellular network, and/or any other suitable network. Computing devices 510 and 540 and data store 520 are in communication over network 530. For example, network 530 can include any technically feasible network hardware suitable for allowing two or more computing devices to communicate with each other and/or to access distributed or remote data storage devices, such as data store 520.

Computing device 540 shown herein is for illustrative purposes only, and variations and modifications in the design and arrangement of computing device 540, without departing from the scope of the present disclosure. For example, the number of processors 542, the number of and/or type of memories 544, and/or the number of applications and or data stored in memory 544 can be modified as desired. In some embodiments, any combination of processor(s) 542 and/or memory 544 can be included in and/or replaced with any type of virtual computing system, distributed computing system, and/or cloud computing environment, such as a public, private, or a hybrid cloud system.

Each of processor(s) 542 can be any suitable processor, such as a CPU, a GPU, an ASIC, an FPGA, a DSP, a multicore processor, and/or any other type of processing unit, or a combination of two or more of a same type and/or different types of processing units, such as a SoC, or a CPU configured to operate in conjunction with a GPU. In general, processors 542 can be any technically feasible hardware unit capable of processing data and/or executing software applications. During operation, processor(s) 542 can receive user input from input devices (not shown), such as a keyboard or a mouse.

Memory 544 of computing device 540 stores content, such as software applications and data, for use by processor(s) 542. As shown, memory 544 includes, without limitation, an artifact detection application 546. Memory 544 can be any type of memory capable of storing data and software applications, such as a RAM, ROM, an EPROM or Flash ROM, or any suitable combination of the foregoing. In some embodiments, additional storage (not shown) can supplement or replace memory 544. The storage can include any number and type of external memories that are accessible to processor(s) 542. For example, and without limitation, the storage can include a Secure Digital Card, an external Flash memory, a portable CD-ROM, an optical storage device, a magnetic storage device, and/or any suitable combination of the foregoing.

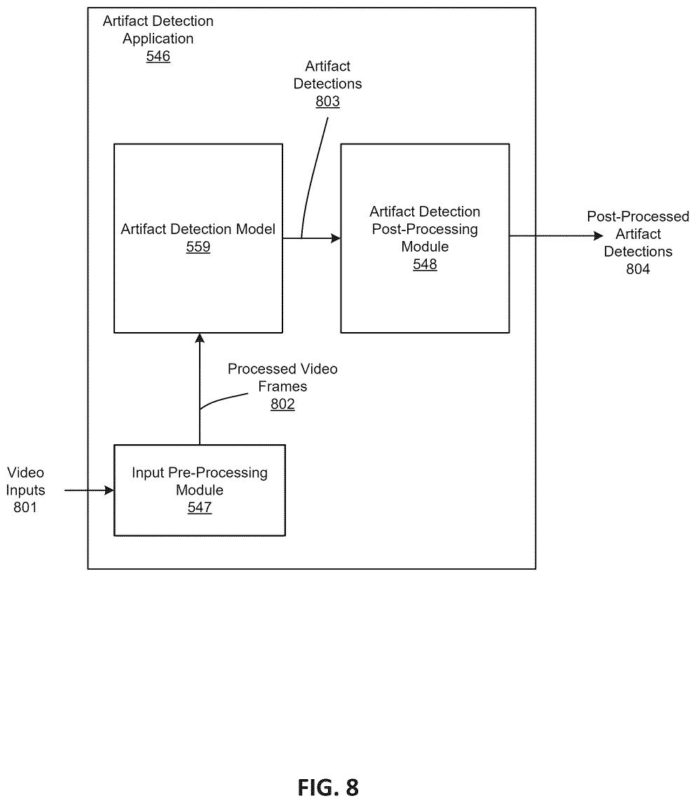

As shown, artifact detection application 546 is stored in memory 544 and executes on processor(s) 542. Artifact detection application 546 includes, without limitation, an input pre-processing module 547 and an artifact detection post-processing module 548. Artifact detection application 546 receives one or more video inputs via one or more I/O device(s) (not shown), such as cameras, video files, streaming services, and/or the like. Based on the one or more video inputs, artifact detection application 546 uses the trained artifact detection model 559 to generate artifact detections. The artifact detections are then used to generate one or more post-processed artifact detections. Artifact detection application 546 is discussed in greater detail below in conjunction with FIG. 8.

Input pre-processing module 547 generates one or more processed video frames based on one or more video inputs. In various embodiments, input pre-processing module 547 processes video inputs, such as raw video files or streaming data, into individual video frames, extracting video frames at predefined intervals or frame rates. In various embodiments, input pre-processing module 547 also performs various operations similar to the operations of data processing module 517 to ensure the video frames are suitable for processing by artifact detection model 559. The operations include resizing the video frames to match the input dimensions suitable for artifact detection model 559, normalizing pixel values to a consistent range (e.g., 0 to 1), and/or the like. Additionally, input pre-processing module 547 organizes the video frames into temporal sequences whenever artifact detection model 559 uses consecutive frames to detect motion-related artifacts. Input pre-processing module 547 also applies various optional preprocessing steps, such as edge enhancement or noise reduction, to emphasize features relevant to artifact detection.

Artifact detection post-processing module 548 processes one or more artifact detections and generates one or more post-processed artifact detections. In various embodiments, following the artifact detection by artifact detection model 559, artifact detection application 546 performs post-processing operations to refine and format the artifact detections for further analysis or visualization. The post-processing operations include but are not limited to generating heatmaps, where each pixel's intensity reflects the confidence of artifact detection model 559 regarding the presence of an artifact. In some embodiments, artifact detection application 546 binarizes the heatmaps using a predefined confidence threshold to separate artifact regions from non-artifact regions, resulting in binary masks that indicate the presence or absence of artifacts. In at least one embodiment, after binarization, artifact detection application 546 applies connected component labeling to group contiguous artifact pixels into discrete labeled regions, enabling the identification of distinct artifact clusters within the processed video frames. In various embodiments, artifact detection application 546 calculates the centroids of the labeled regions, providing (x,y) coordinates for each detected artifact. In various embodiments, artifact detection application 546 provides various interfaces for displaying or accessing artifact detections. In some embodiments, artifact detection application 546 generates post-processed artifact detections as structured output via a Docker container for integration with automated workflows. Alternatively, artifact detection application 546 uses a command-line interface to generate post-processed artifact detections as JSON output, allowing artifact detections to be easily parsed. In at least one embodiment, artifact detection application 546 provides a graphical display of artifact detections through a visual user interface, enabling users to view post-processed artifact detections which include artifact locations overlaid on video frames for inspection.

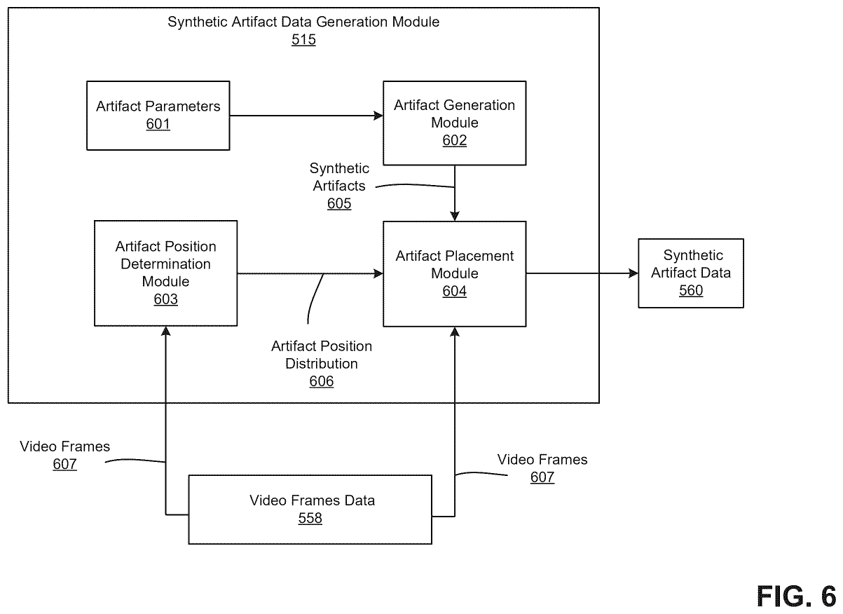

FIG. 6 is a more detailed illustration of synthetic artifact data generation module 515, according to various embodiments. Synthetic artifact data generation module 515 processes one or more video frames 607 and generates synthetic artifact data 560. As shown, synthetic artifact data generation module 515 includes, without limitation, artifact parameters 601, artifact generation module 602, artifact position determination module 603, and artifact placement module 604.

Artifact parameters 601 include various artifact attributes, such as the type, shape, size, intensity, orientation, color, and/or the like. Artifact parameters 601 define the specific characteristics of synthetic artifacts 605, enabling synthetic artifacts 605 to closely mimic real-world pixel-level anomalies. For example, the type parameter determines whether the synthetic artifact 605 is symmetrical, such as a hot pixel, or curvilinear, such as a streak or scratch. The shape and size parameters control the geometric dimensions of the synthetic artifact 605, ensuring the synthetic artifact 605 aligns with realistic proportions observed in real-world artifacts. The intensity parameter specifies the brightness of synthetic artifacts 605, which can be adjusted to match varying levels of prominence depending on the context. For example, high-intensity synthetic artifacts 605 could simulate bright sensor defects, while low-intensity artifacts could represent more subtle imperfections. The orientation parameter applies primarily to curvilinear artifacts, defining the direction and angle of streaks or scratches. The orientation parameter includes random or predefined alignments to simulate motion blur or lens scratches in video editing or directional noise patterns in medical imaging. The color parameter introduces variability by defining the hue, saturation, and brightness of synthetic artifact 605, allowing the generation of both grayscale and RGB synthetic artifacts 605.

Artifact generation module 602 generates one or more synthetic artifacts 605 based on artifact parameters 601. In some embodiments, artifact generation module 602 generates symmetrical artifacts included in synthetic artifacts 605. In some embodiments, artifact generation module 602 generates symmetrical artifacts using anisotropic Gaussian distributions to replicate pixel anomalies that are symmetrical along at least one axis, such as hot pixels caused by camera sensor defects and/or the like. For symmetrical artifacts, artifact generation module 602 uses artifact parameters 601, such as scale (σ₁ and σ₂), orientation (θ), hue, intensity, and/or asymmetry factors. For example, the Gaussian kernel for symmetrical artifacts can be defined as:

$$k ( x , y ) = exp ( - \frac{{x}_{rot}^{2}}{2 {σ}_{1}^{2}} - \frac{{y}_{rot}^{2}}{2 {σ}_{2}^{2}} ) \qquad ( Equation 1 )$$

where xᵣₒₜ and yᵣₒₜ are the rotated coordinates computed as:

$${x}_{rot} = x cos ( θ ) + y sin ( θ ) , {y}_{rot} = - x sin ( θ ) + y cos ( θ ) \qquad ( Equation 2 )$$

In some examples, the base spread of the Gaussian kernel in Equation 1 is determined by sampling σ₁ from a normal distribution with mean of 0.1 and standard deviation of 0.6, an asymmetry factor (e.g., spread_factor) is sampled from a normal distribution with mean of 1 and standard deviation of 0.25 to compute σ₂=σ₁×spread_{factor}, and the Gaussian kernel in Equation 1 is rotated by an angle θ, sampled uniformly between 0 and π, to add randomness to the artifact orientation. In at least one embodiment, artifact generation module 602 generates curvilinear artifacts included in synthetic artifacts 605. In various embodiments, artifact generation module 602 generates curvilinear artifacts, such as streaks or scratches, using directional random walks. Curvilinear artifacts are defined by artifact parameters 601 including but not limited to line length (L), direction vectors (\vec{d}), and intensity (c). In various embodiments, artifact generation module 602 generates curvilinear artifacts by starting a random walk at the center of the video frame 607, and for each step: (i) chooses a direction randomly from predefined options (e.g., horizontal or vertical) and (ii) updates the position as:

$$( {x}_{i + 1} , {y}_{i + 1} ) = ( {x}_{i} , {y}_{i} ) + \vec{d} \qquad ( Equation 3 )$$

At each step, intensity (cᵢ) is sampled randomly and applied to the pixel. The intensity is normalized and scaled to simulate realistic brightness variations. The resulting path is then smoothed using Gaussian blur to create a streak-like synthetic artifact 605:

$$p ( x , y ) = GaussianBlur ( {\sum }_{i = 1}^{L} δ ( x - {x}_{i} , y - {y}_{i} ) \cdot {c}_{i} ) \qquad ( Equation 4 )$$

where δ is the Dirac delta function marking the pixel positions, and cᵢ is the intensity at each step.

Artifact position determination module 603 generates artifact position distribution 606 based on video frames 607. In various embodiments, artifact position determination module 603 uses various metrics calculated based on video frames 607, such as brightness values, edge values, movement values, and/or the like, to generate artifact position distribution 606. In some embodiments, artifact position determination module 603 calculates the brightness values in a sequence of steps to determine the average pixel intensity across the grayscale version of video frames 607. First, video frames 607 are converted from original color format (e.g., RGB) to grayscale, where each pixel is reduced to a single intensity value representing the luminance. For each pixel location (x,y) across a set of N frames, the intensity values are averaged along the temporal axis to generate a brightness map. In some examples, the brightness at each pixel location is computed using the equation:

$$brightness ( x , y ) = \frac{1}{N} {\sum }_{i = 1}^{N} {frames\_gray}_{i} ( x , y ) \qquad ( Equation 5 )$$

where frames_gray (x,y) is the grayscale intensity of the pixel at (x,y) in the i-th frame. Equation 5 ensures that temporal variations in pixel intensity, such as flickering or movement, are accounted for when identifying regions of consistent brightness. Once the brightness values are computed, brightness (x,y) can be used to identify darker regions of video frames 607, which are more suitable for placing synthetic artifacts 605, such as hot pixels. In at least one embodiment, artifact position determination module 603 calculates edge values by determining the magnitude of gradients in video frames 607, which represent transitions in pixel intensity and highlight areas with high contrast, such as object boundaries, edges, and/or the like. In some examples, to compute edge values, artifact position determination module 603 uses Sobel operators, which are applied to each video frame 607 to calculate intensity gradients in the horizontal (x) and vertical (y) directions. For a pixel at location (x,y), the gradients are computed as:

$${grad}_{x} ( x , y ) = sobel\_filter ( frame , direction = ‘ x ’ ) , \qquad ( Equation 6 )$$

$${grad}_{y} ( x , y ) = sobel\_filter ( frame , direction = ‘ y ’ ) ,$$

where gradₓ and grad_{y} are the horizontal and vertical gradients, respectively. The edge magnitude at each pixel is then computed as the Euclidean norm of the gradients in Equation 6:

$$edges ( x , y ) = \sqrt{{{grad}_{x} ( x , y )}^{2} + {{grad}_{y} ( x , y )}^{2} .} \qquad ( Equation 7 )$$

The edge magnitude is normalized by dividing each value by the maximum gradient magnitude in video frame 607 plus a small value e to avoid division by zero:

$$edges ( x , y ) = \frac{edges ( x , y )}{max ( edges ) + ϵ} . \qquad ( Equation 8 )$$

The resulting edge map edges (x,y) emphasizes areas of high intensity transitions, such as object outlines, sharp boundaries, and/or the like. The edge values are used to guide the placement of synthetic artifacts 605, ensuring synthetic artifacts 605 are positioned in regions where real-world artifacts are likely to occur, such as along edges or object boundaries. In some embodiments, artifact position determination module 603 calculates movement values by analyzing the temporal differences between consecutive grayscale video frames 607, capturing regions with significant pixel intensity changes over time, indicative of motion. In some examples, to compute movement values, artifact position determination module 603 first converts video frames 607 to grayscale, simplifying the data to intensity values. Temporal differences are then computed for each pixel location (x,y) by subtracting the intensity of the corresponding pixel in the previous frame from the current frame:

$${frame}_{{diffs}_{i} ( x , y )} = {frames}_{{gray}_{i + 1}} ( x , y ) - {frames}_{{gray}_{i}} ( x , y ) . \qquad ( Equation 9 )$$

The temporal differences are aggregated across all frames to compute the motion map using the L1 norm, which sums the absolute differences for each pixel across the temporal sequence:

$$motion ( x , y ) = {\sum }_{i = 1}^{N - 1} \vert {frame}_{{diffs}_{i}} ( x , y ) \vert \qquad ( Equation 10 )$$

To ensure consistency and scale invariance, the movement values are normalized by dividing each value by the maximum motion value in the map plus a small value e to avoid division by zero:

$$motion ( x , y ) = \frac{motion ( x , y )}{max ( motion ) + ϵ} \qquad ( Equation 11 )$$

The resulting motion map motion (x,y) highlights areas with important temporal changes, such as moving objects or dynamic regions, while static regions appear with low motion values. The movement values are used to guide the placement of synthetic artifacts 605 by prioritizing static areas, where artifacts, such as hot pixels, are more likely to be detected as anomalies. In various embodiments, artifact position determination module 603 generates artifact position distribution 606 based on brightness values, edge values, movement values, and/or the like, to create a sampling probability map that determines the likelihood of placing synthetic artifacts 605 at specific pixel locations in video frames 607. In some examples, in order to generate artifact position distribution 606, artifact position determination module 603, first generates a probability map by weighting the complement of each metric, such as movement values, edges values, and brightness values, to prioritize regions that are static, low-contrast, and dark, as the areas are more realistic for artifact placement. In some examples, the combined probability for a pixel at location (x,y) can be computed as:

$${prob}_{map ( x , y )} = 1 - ( 1 - motion ( x , y ) ) \cdot ( 1 - edges ( x , y ) ) \cdot ( 1 - brightness ( x , y ) ) \qquad ( Equation 12 )$$

which ensures that higher values in the probability map represent areas less likely to receive synthetic artifacts 605, while lower values indicate preferred locations. Next, the probability map is processed to refine the distribution. A dilation operation is applied to expand high-probability regions, ensuring artifacts are not placed too close to dynamic, high contrast, or bright areas. Additionally, a boundary mask is applied to avoid placing artifacts near the edges of the frame, as near the edge areas introduce visual inconsistencies. Finally, the processed probability map is flattened and inverted to create a sampling distribution where lower values correspond to higher placement probabilities. The distribution is normalized to ensure that the probabilities sum to 1, forming a valid probability distribution for sampling artifact positions:

$$prob\_dist ( x , y ) = 1 ( prob\_map ( x , y ) - ) = / ( {\sum }_{-} ( x , y ) ( 1 ( prob\_map ( x , y ) - ) ) ) ) \qquad ( Equation 13 )$$

Artifact placement module 604 then generates artifact position distribution 606 prob_{dist(x,y)}, which enables targeted and realistic placement of synthetic artifacts 605, ensuring synthetic artifacts 605 appear in visually plausible locations, such as low-motion, low-brightness, and low-edge regions, while avoiding areas that could introduce unrealistic scenarios.

Artifact placement module 604 generates synthetic artifact data 560 based on synthetic artifacts 605, artifact position distribution 606, and video frames 607. Using synthetic artifacts 605 generated by artifact generation module 602, artifact placement module 604 determines suitable locations for placing (e.g., superimposing) synthetic artifacts 605 within video frames 607 by sampling positions from the artifact position distribution 606. In various embodiments, for each synthetic artifact 605, artifact placement module 604 first determines artifact type, such as curvilinear artifacts and symmetrical artifacts based on a predefined proportion. In some examples, if a random value r satisfies r<p_{curvilinear}, where p_{curvilinear} is the proportion of curvilinear artifacts, a curvilinear synthetic artifact 605 is selected; otherwise, a symmetrical artifact is selected. The intensity of the artifact is scaled randomly as I=I_{base}·s, where s is sampled from a uniform distribution U(0.5,1) and I_{base} is the base intensity. Once the artifact type is determined, artifact placement module 604 samples a position for the synthetic artifact 605 from the artifact position distribution 606, which provides a probability map indicating preferred locations for artifact placement. The sampling process selects an index i from artifact position distribution 606 prob_{dist} as defined in Equation 13, and the corresponding spatial coordinates (x,y) are derived as

$$x , y = {unravel}_{index ( i , {prob}_{map} . shape )} , \qquad ( Equation 14 )$$

where the function unravel_index in Equation 14 is used to map a single sampled index i, drawn from the flattened probability distribution probₘₐₚ.shape, back to the corresponding spatial coordinates (x,y) in the 2D probability map. The sampled position is adjusted to center the synthetic artifact 605 within the target area by calculating the starting x and y coordinates as x_“start”=max (0, x−|−w_a/2) and

$${y}_{start} = max ( 0 , y - \frac{{h}_{a}}{2} ) ,$$

where wₐ and hₐ are the width and height of synthetic artifact 605. In various embodiments, artifact placement module 604 clips the starting coordinates to ensure that the artifact fits within the bounds of the frame, for example, using xₛₜₐᵣₜ=min (xₛₜₐᵣₜ, W−wₐ) and yₛₜₐᵣₜ=min(yₛₜₐᵣₜ, H−hₐ), where W and H are the width and height of the video frame 607. Once the position is determined, artifact placement module 604 superimposes synthetic artifact 605 onto the video frame 607 by blending the synthetic artifact 605 with the existing pixel values at the selected position. In some embodiments, for each pixel (i,j) in the artifact patch, artifact placement module 605 computes the updated pixel value in the video frame 607

$$[ {y}_{start} + i , {x}_{start} + j ] = min ( frame [ {y}_{start} + i , {x}_{start} + j ] + artifact [ i , j ] , 1 ) \qquad ( Equation 15 )$$

ensuring that pixel values remain within the normalized range of 0 to 1. Whenever video frames 607 include a plurality of frames, the synthetic artifact 605 is typically applied to the center frame of the sequence to maintain temporal consistency. Artifact placement module 604 also updates a noise map to track the placement and intensity of synthetic artifacts 605. In some example, the noise map N is updated as

$$N [ {y}_{start} + i , {x}_{start} + j ] = min ( N [ {y}_{start} + i , {x}_{start} + j ] + artifact [ i , j ] , 1 ) \qquad ( Equation 16 )$$

ensuring that overlapping synthetic artifacts 605 are handled appropriately and artifact visibility remains realistic. The resulting synthetic artifact data 560 includes video frames with artifacts placed in visually plausible locations, based on artifact position distribution 606 and the underlying characteristics of the video frames 607. In various embodiments, artifact placement module 604 superimposes symmetrical artifacts on low-motion, dark regions of video frames 607 to mimic real-world conditions, such as bright sensor defects appearing in otherwise uniform areas. In at least one embodiment, artifact placement module 604 aligns curvilinear artifacts with high-contrast edges or smooth gradients in video frames 607 to mimic real-world streaking artifacts observed in motion blur or lens scratches.

FIG. 7A is a more detailed illustration of the model trainer 514 training artifact detection model 559, according to various embodiments. Model trainer 514 performs one or more training operations based on training artifact data 557 to train artifact detection model 559. Training artifact data 557 includes, without limitation, synthetic artifact data 560 from which video frames 701 are selected and then processed by data processing module 517 to generate processed video frames 702. As shown, model trainer 514 uses loss 705 generated based on artifact detections 703 generated by artifact detection model 559 from processed video frames 702 and ground truth artifacts 704 included in synthetic artifact data 560 to train artifact detection model 559.

In operation, data processing module 517 generates processed video frames 702 based on video frames 701 included in synthetic artifact data 560. Data processing module 517 processes video frames 701 to ensure compatibility with artifact detection model 559 by performing various processing steps. In some embodiments, data processing module 517 resizes video 701 to match the input dimensions expected by artifact detection model 559. For example, a video frame 701 with a resolution of 1920×1080 can be resized to 224×224 to ensure the video frames 701 aligns with the architecture requirements of artifact detection model 559. In various embodiments, data processing module 517 normalizes the pixel values in video frames 701 to a predefined range, such as 0 to 1 or −1 to 1, to standardize the input data and facilitate training or inference of artifact detection model 559. Additionally, data processing module 517 organizes video frames 701 into temporal sequences whenever artifact detection model 559 uses spatiotemporal features. For example, if artifact detection model 559 processes a sliding window of five consecutive video frames to capture motion-related artifacts, data processing module 517 ensures video frames 701 are properly aligned and formatted for input, preserving temporal consistency. In some embodiments, data processing module 517 also applies noise reduction techniques to remove irrelevant information and edge-enhancement filters to emphasize features important for artifact detection, such as hot pixels, streaks, compression artifacts, and/or the like.

Artifact detection model 559 generates one or more artifact detections 703 based on processed video frames 701. During training, artifact detection model 559 uses the current set of parameters to process processed video frames 701 and detect potential artifacts, such as hot pixels, streaks, pixel-level anomalies, and/or the like. In some embodiments, in the initial stages of training, model trainer 514 chooses the parameters of artifact detection model 559 randomly or initializes the parameters using standard techniques, such as Xavier initialization, He initialization, and/or the like, to ensure appropriate weight distributions across various layers included in artifact detection model 559.

Loss calculation module 518 generates loss 705 based on ground truth artifacts 704 and artifact detections 703. In various embodiments, loss calculation module 518 generates loss 705 based on the difference between the artifact detections 703 and the actual artifact annotations included in ground truth artifacts 704, guiding the optimization of artifact detection model 559 during training by model trainer 514. For example, loss calculation module 518 can compute a pixel-wise binary cross-entropy loss, comparing each pixel in the output heatmap included in artifact detections 703 against the corresponding ground truth artifacts 704 to determine whether the output heatmap correctly identifies the artifact. In some embodiments, loss calculation module 518 uses a combination of loss functions to improve the detection performance of artifact detection model 559. For example, loss calculation module 518 can combine cross-entropy loss with Dice coefficient loss, which measures the overlap between predicted artifact regions and ground truth regions, ensuring accurate localization of artifacts. For example, in medical imaging, loss calculation module 518 can calculate loss 705 by comparing the predicted artifact masks included in artifact detections 703 with the corresponding ground truth masks included in ground truth artifacts 704. In some embodiments, loss calculation module 518 applies weighting to certain types of discrepancies between artifact detections 703 and ground truth artifacts 704, prioritizing specific error types for correction. For example, loss calculation module 518 can penalize false positives more heavily in regions where no artifacts are expected, to reduce over-detection, or penalize false negatives more heavily in areas with known artifacts.

Model trainer 514 updates one or more parameters of artifact detection model 559 based on loss 705. In various embodiments, model trainer 514 updates the one or more parameters of artifact detection model 559 by iteratively using optimization algorithms, such as stochastic gradient descent (SGD), adaptive moment estimation (Adam), and/or the like, to minimize loss 705 and improve the detection accuracy of artifact detection model 559. At each iteration, the gradients of loss 705 with respect to the parameters of artifact detection model 559 are computed, and the parameters are updated in the direction that reduces loss 705. In some embodiments, model trainer 514 uses an EMA for the weights of artifact detection model 559 during training. EMA maintains a smoothed version of the one or more parameters of artifact detection model 559 by averaging weights over multiple training iterations, for example, using the formula:

$${θ}_{EMA}^{( t )} = α \cdot {θ}_{EMA}^{( t - 1 )} + ( 1 - α ) \cdot {θ}^{( t )} , \qquad ( Equation 17 )$$

where θ^{(t)} are the current parameters,

$${θ}_{EMA}^{( t - 1 )}$$

are the EMA parameters from the previous iteration t−1, and α is the smoothing factor. EMA stabilizes training by reducing the impact of noisy updates and often results in improved artifact detection performance during inference by using the averaged parameters for artifact detections 703. In various embodiments, model trainer 514 employs one or more stopping criteria to determine when training should be terminated. In some embodiments, model trainer 514 stops training artifact detection model 559 when loss 705 reaches a predefined threshold, indicating sufficient detection accuracy, or when loss 705 plateaus across several consecutive iterations, signaling that further training yields diminishing improvements. Additionally, model trainer 514 stops training artifact detection model 559 after a fixed number of iterations or epochs, or when artifact detection model 559 achieves a target detection performance metric, such as precision, recall, Dice coefficient, and/or the like, on a validation dataset included in training artifact data 557.

FIG. 7B is a more detailed illustration of the refinement data selection module 516, according to various embodiments. As shown, data processing module 517 generates one or more processed video frames 712 based on one or more video frames 711 included in video frames data 558. Video frames data 558 includes, without limitation, real-world video frames or images that may or may not have artifact annotations (e.g., labels), providing a plurality of examples for refinement. Refinement data selection module 516 uses artifact detection model 559, which is trained on synthetic artifact data 560, to process one or more processed video frames 712 and generate one or more artifact labels 714.

In operation, data processing module 517 generates one or more processed video frames 712 based one or more video frames 711 from video frames data 558. Data processing module 517 processes video frames 711 to ensure compatibility with artifact detection model 559 by performing various preprocessing steps. In some embodiments, data processing module 517 resizes video frames 711 to match the input dimensions expected by artifact detection model 559. In various embodiments, data processing module 517 normalizes the pixel values in video frames 711 to a predefined range, such as 0 to 1 or −1 to 1, to standardize the input data and facilitate the training or inference process of artifact detection model 559. Additionally, data processing module 517 organizes video frames 711 into temporal sequences whenever artifact detection model 559 uses spatiotemporal features. Furthermore, data processing module 517 applies noise reduction techniques to video frames 711 to remove irrelevant information that could interfere with artifact detection and applies edge-enhancement filters to emphasize features important for identifying anomalies, such as hot pixels, streaks, compression artifacts, or similar pixel-level errors.

The trained artifact detection model 559 generates one or more artifact detections 713 based on one or more processed video frames 712. The trained artifact detection model 559 detects artifacts, such as hot pixels, streaks, and compression artifacts, in processed video frames 712. Artifact detections 713 generated by artifact detection model 559 include both correct and incorrect detections. Incorrect detections fall into two primary categories: false positives and false negatives. False positives occur when artifact detection model 559 incorrectly detects an artifact in a region where no artifact exists. For example, a bright reflection in a processed video frame 712 could be misclassified by the trained artifact detection model 559 as a hot pixel. False negatives occur when the trained artifact detection model 559 fails to detect an actual artifact. For example, a faint streak artifact could be overlooked in a high-motion region of a processed video frame 712.

Refinement data selection module 516 generates artifact labels 714 based on one or more artifact detections 713. In various embodiments, refinement data selection module 516 selects frames that have false positive labels included in one or more artifact detections 713 and generates corresponding artifact labels 714 using various approaches. In some embodiments, refinement data selection module 516 compares artifact detections 713 against a corpus of frames labeled with ground truth artifacts, automatically identifying discrepancies. For example, if the ground truth data specifies no artifacts in a particular region, but artifact detection model 559 flags a reflection as a hot pixel, a false positive label is selected. In medical imaging, any artifact detection in a region confirmed by ground truth to have no streaking artifacts is labeled as a false positive and included in one or more artifact labels 714. In some embodiments, refinement data selection module 516 uses manual reviews where human operators examine artifact detections 713. For example, a human operator could review a bright spot flagged as a hot pixel in a video frame and determine the spot is a reflection, assigning a false positive label. In addition to manual reviews, refinement data selection module 516 uses various automated approaches. One automated approach includes analyzing one or more confidence scores included in artifact detections 713, where artifact detections 713 with low confidence are flagged as potential false positives. For example, a low-confidence detection of a streak in a CT scan could be automatically labeled as a false positive. Another automated approach uses ensemble-based consensus, comparing outputs from multiple artifact detection models to flag inconsistencies. For example, a specular highlight misclassified by one artifact detection model but not other artifact detection models could be identified as a false positive. Temporal or spatial consistency checks provide yet another automated approach, identifying artifact detections 713 that do not persist across consecutive frames or appear isolated in static regions. For example, a transient noise pattern detected in one frame but not in others could be flagged as a false positive. Once one or more artifact labels 714 are generated, refinement data selection module 516 stores one or more artifact labels 714 in refinement data 561, which includes annotations (e.g., artifact labels 714) for both true artifacts and false positives.

FIG. 7C is a more detailed illustration of the model trainer 514 re-training artifact detection model 559, according to various embodiments. As shown, model trainer 514 uses both synthetic artifact data 560 and refinement data 561 included in training artifact data 557 to re-train artifact detection model 559.

In operation, data processing module 517 generates one or more processed video frames 702 based on one or more video frames 701 from training artifact data 557, which includes video frames or images with artifact labels 714. Artifact detection model 559 generates artifact detections 703 based on processed video frames 702. Loss calculation module 518 generates loss 705 based on artifact detections 703 and ground truth artifacts 704 included in training artifact data 557. In various embodiments, training artifact data 557 includes one or more batches of synthetic artifact data 560 and refinement data 561. Model trainer 514 retrains artifact detection model 559 and updates one or more parameters of artifact detection model 559 based loss 705. In some embodiments, in iterative training processes, model trainer 514 uses staged optimization, alternating between training artifact detection model 559 using one or more batches of synthetic artifact data 560 and refinement data 561. During each iteration, model trainer 514 evaluates the precision and recall of artifact detection model 559 on previously unseen batches of synthetic artifact data 560 and refinement data 561. By identifying patterns in false positives and minimizing the occurrences of false positive artifact detections 703, model trainer 514 progressively improves artifact detection model 559. In various embodiments, model trainer 514 includes feedback from evaluating the precision and recall of artifact detection model 559, refining artifact detection model 559 to reduce loss 705. The parameters of artifact detection model 559 are iteratively updated, and the re-training process continues until predefined performance metrics, such as precision, recall, loss convergence, and/or the like, are achieved. By alternating between synthetic artifact data 560 and refinement data 561, model trainer 514 uses both controlled synthetic examples and real-world corrections to achieve high accuracy and reliability in various artifact detection tasks.

FIG. 8 is a more detailed illustration of artifact detection application 546, according to various embodiments. As shown, artifact detection application 546 includes, without limitation, input pre-processing module 547 and the trained artifact detection model 559. Artifact detection application 546 receives one or more video inputs via one or more I/O device(s) (not shown), such as cameras, video files, streaming services, and/or the like. Input pre-processing module 547 generates one or more processed video frames 802 based on one or more video inputs 801. Artifact detection application 546 uses the trained artifact detection model 559 to generate artifact detections 803 based on one or more processed video frames 802. Artifact detection post-processing module 548 generates one or more post-processed artifact detections 804 based on one or more artifact detections 803.

Input pre-processing module 547 generates processed video frames 802 based on video inputs 801. In various embodiments, input pre-processing module 547 processes video inputs 801, such as raw video files, streaming data, or image sequences, into individual video frames by extracting frames at predefined intervals or specific frame rates. Input pre-processing module 547 ensures the processed video frames 802 are appropriately formatted for subsequent analysis by artifact detection model 559 by performing various preprocessing operations. Similar to the operations of data processing module 517, input pre-processing module 547 resizes video frames included in video inputs 801 to match the input dimensions of artifact detection model 559. For example, a video input 801 with a resolution of 1920×1080 could be resized to 224×224 to align with the architecture of artifact detection model 559. Input pre-processing module 547 also normalizes pixel values within a consistent range, such as 0 to 1, to standardize the data. In various embodiments, input pre-processing module 547 organizes video frames included in video inputs 801 into temporal sequences whenever artifact detection model 559 relies on spatiotemporal features for artifact detection. For example, if the artifact detection model 559 analyzes a sliding window of five consecutive frames to detect motion-related artifacts, input pre-processing module 547 ensures that the video frames included in video inputs 801 are aligned and formatted to preserve temporal coherence. In some embodiments, input pre-processing module 547 performs optional preprocessing steps, such as edge enhancement or noise reduction, to emphasize features relevant to artifact detection, such as bright spots, streaks, patterns, and/or the like, indicative of artifacts.

Artifact detection application 546 uses the trained artifact detection model 559 to generate one or more artifact detections 803 based on processed video frames 802. In various embodiments, the trained artifact detection model 559 processes one or more processed video frames 802 using various operations, such as convolutions, maxpooling, downscaling, upscaling, bottlenecking, and/or the like, to extract and analyze spatial and visual features associated with artifacts. In some embodiments, the trained artifact detection model 559 uses temporal information whenever the one or more processed video frames 802 include consecutive video frames, to detect motion-related artifacts or distinguish transient noise from persistent anomalies (e.g., artifacts). In at least one embodiment, the trained artifact detection model 559 includes one or more convolution blocks. In some embodiments, each convolution block includes a convolution unit for feature extraction, a group normalization module to normalize feature maps and improve training stability, and a SiLU activation function to introduce non-linearity, enhancing the ability of the trained artifact detection model 559 to capture nonlinear patterns associated with artifacts. In some embodiments, the trained artifact detection model 559 includes a padding module that processes the processed video frames and generates padded video frames to ensure compatibility with the architecture of the trained artifact detection model 559, especially when the frame dimensions are not evenly divisible by the required input size of the convolutional layers included in the trained artifact detection model 559.

Artifact detection post-processing module 548 processes one or more artifact detections 803 and generates one or more post-processed artifact detections 804. In various embodiments, following the artifact detection by artifact detection model 559, artifact detection application 546 performs post-processing operations to refine and format the artifact detections 803 for further analysis or visualization. The post-processing operations include but are not limited to generating heatmaps, where each pixel's intensity reflects the confidence of artifact detection model 559 regarding the presence of an artifact. In some embodiments, artifact detection application 546 binarizes the heatmaps using a predefined confidence threshold to separate artifact regions from non-artifact regions, resulting in binary masks that indicate the presence or absence of artifacts. In at least one embodiment, after binarization, artifact detection application 546 applies connected component labeling to group contiguous artifact pixels included in artifact detections 803 into discrete labeled regions, enabling the identification of distinct artifact clusters within the processed video frames 802. In various embodiments, artifact detection application 546 calculates the centroids of the labeled regions, providing (x,y) coordinates for each detected artifact. In various embodiments, artifact detection application 546 provides various interfaces for displaying or accessing artifact detections 803. In some embodiments, artifact detection application 546 generates post-processed artifact detections 804 as structured output via a Docker container for integration with automated workflows. Alternatively, artifact detection application 546 uses a command-line interface to generate post-processed artifact detections 804 as JSON output, allowing artifact detections 803 to be easily parsed. In at least one embodiment, artifact detection application 546 provides a graphical display of artifact detections 803 through a visual user interface, enabling users to view post-processed artifact detections 804 which include artifact locations overlaid on video frames for inspection.

FIG. 9A is a more detailed illustration of the artifact detection model 559, according to various embodiments. Artifact detection model 559 includes, without limitation, a padding module 900, convolution layers 901A and 901B, a downscaling module 902, a bottleneck module 903, an upscaling module 904, and a sigmoid layer 905. As shown, padding module 900 generates one or more padded video frames 906 based on one or more processed video frames 802. Convolution layer 901A generates one or more convolution features 907 based on one or more padded video frames 906. Downscaling module 902 generates one or more downscaled features 908 based on one or more convolution features 907. Bottleneck module 903 generates one or more bottlenecked features 909 based on one or more downscaled features 908. Upscaling module 904 generates one or more upscaled features 910 based on one or more downscaled features 908 and one or more bottlenecked features 909. Convolution layer 901B generates one or more processed convolution features 911 based on one or more upscaled features 910. Sigmoid layer 905 generates one or more artifact detections 803 based on one or more processed convolution features 911.

Padding module 900 processes one or more processed video frames 802 and generates one or more padded video frames 906. In various embodiments, padding module 900 processes a plurality of processed video frames 802 (e.g., 5 frames) at a time flattened across a channel dimension. A channel refers to the different layers of information in a video frame or image that represent specific types of data for each pixel. For example, a color image or video frame can have channels, such as red, green, and blue (RGB). In various embodiments, padding module 900 ensures that the dimensions of the processed video frames 802 are compatible with the input requirements of artifact detection model 559, which is particularly important when the dimensions of the processed video frames 802 are not evenly divisible by the expected input size of convolutional layer 901A in artifact detection model 559. For example, if a processed video frame 802 has a resolution of 1080×1920, which is not divisible by 16, padding module 900 adds additional rows and/or columns of pixels around the frame to bring the dimensions to the nearest compatible size, such as 1088×1920. The pixel values can be set to zero or a constant value to minimize the impact on feature extraction by artifact detection model 559. In at least one embodiment, padding module 900 applies padding symmetrically around the edges of processed video frames 802 to preserve the central features while ensuring padded video frame 906 align correctly with the architecture of artifact detection model 559.

Convolution layer 901A processes one or more padded video frames 906 and generates one or more convolution features 907. In various embodiments, convolution layer 901A extracts spatial features from padded video frames 906 by applying convolutional filters that scan across padded video frames 906 in a sliding window fashion. Each filter detects specific patterns such as edges, textures, or other visual structures associated with artifacts. The result of applying convolutional filters is a set of feature maps, referred to as convolution features 907, that highlight the presence of the patterns at different locations within padded video frames 906. For example, if a padded video frame 906 contains a streak-like artifact, convolution layer 901A could generate a feature map where high-intensity values correspond to the locations of the streak. The convolution operation is defined mathematically as:

$$C ( i , j ) = {\sum }_{m} {\sum }_{n} P ( i + m , j + n ) \cdot K ( m , n ) \qquad ( Equation 18 )$$

where C(i,j) represents the convolution feature 907 at position (i,j), P(i+m, j+n) is the pixel intensity in the padded video frame 906 at position (i+m, j+n), and K(m,n) is the value of the convolutional filter kernel at position (m,n). In various embodiments, convolution layer 901A includes wide convolution layers, allowing for the capture of low-level patterns important for detecting pixel-level artifacts. For example, hot pixels, which manifest as pixel-level artifacts, are often characterized by subtle variations in intensity or color that are indistinguishable in higher-level feature representations.

Downscaling module 902 processes convolution features 907 and generates downscaled features 908. In various embodiments, downscaling module 902 reduces the spatial dimensions of the convolution features 907 while retaining the most significant information, enabling artifact detection model 559 to focus on high-level patterns and reduce computational complexity. In various embodiments, downscaling module 902 generates downscaled features 908 by various techniques, such as max-pooling, average pooling, and/or the like. For example, in max-pooling, downscaling module 902 divides each feature map included in one or more convolution features 907 into nonoverlapping regions (e.g., 2×2 or 3×3 grids) and retains only the maximum value from each region. Mathematically, this operation is expressed as:

$$D ( i , j ) = {max}_{⊤} ( ( m , n ) ∈ R ( i , j ) ) C ( m , n ) \qquad ( Equation 19 )$$

where D(i,j) represents the downscaled feature 908 at position (i,j), C (m,n) represents the convolution feature 907 within the region R (i,j), and max selects the highest value in the region. By retaining the most prominent values, max-pooling helps preserve the strongest artifact-related signals while discarding less relevant details. In some embodiments, downscaling module 902 reduces the size of the feature maps included in convolution features 907. In some embodiments, downscaling module 902 uses extremum pooling, which retains both the maximum and minimum values within a region, emphasizing regions with both strong positive and negative feature intensities. Downscaling module 902 is described in more detail in conjunction with FIG. 9B.

Bottleneck module 903 processes downscaled features 908 and generates bottlenecked features 909. In various embodiments, bottleneck module 903 reduces the number of feature channels in downscaled features 908 while retaining the most salient and high-level features for artifact detection. In various embodiments, bottleneck module 903 compresses downscaled features 908, reducing redundancy and computational complexity in subsequent layers of artifact detection model 559. In some embodiments, bottleneck module 903 employs convolutional operations with a smaller number of filters to achieve dimensionality reduction. Mathematically, the processing of bottlenecked features 909 can be expressed as:

$${B}_{k} ( i , j ) = {\sum }_{c = 1}^{C} {\sum }_{m} {\sum }_{n} {D}_{c} ( i + m , j + n ) \cdot {K}_{c , k} ( m , n ) , \qquad ( Equation 20 )$$

where Bₖ(i,j) represents the bottlenecked feature 909 at channel k and spatial position (i,j), D_{c}(i+m, j+n) is the downscaled feature 908 at channel c and spatial position (i+m,j+n), K_{c,k}(m,n) is the convolutional kernel connecting channel c in the input to channel k in the output bottlenecked feature 909, and C is the total number of input channels in downscaled feature 908. Bottleneck module 903 is described in more detail in conjunction with FIG. 9C.

Upscaling module 904 processes downscaled features 908 and bottlenecked features 909 and generates upscaled features 910. In various embodiments, upscaling module 904 employs various techniques to generate upscaled features 910 and reconstruct spatial resolution, including nearest-neighbor interpolation, bilinear interpolation, transposed convolutions (also known as deconvolutions), depth-to-space transformation, and/or the like. For example, in nearest-neighbor interpolation, the value of each pixel in the upscaled feature map is taken from the nearest pixel in the lower-resolution feature map, and this is mathematically expressed as:

$$U ( i , j ) = B ( ⌊ \frac{i}{s} ⌋ , ⌊ \frac{j}{s} ⌋ ) \qquad ( Equation 21 )$$

where U(i,j) represents the upscaled feature 910 at position (i,j),

$$B ( ⌊ \frac{i}{s} ⌋ , ⌊ \frac{j}{s} ⌋ )$$

is the bottlenecked feature 909 value at the nearest lower-resolution position, and s is the scaling factor. In depth-to-space transformation, upscaling module 904 rearranges the feature channels into spatial dimensions, effectively increasing the spatial resolution of the feature map included in bottleneck features 909 and downscaled features 908. For example, if the bottlenecked features 909 have dimensions (H, W, C×r²), where H and W are the spatial dimensions, C is the number of feature channels, and r is the upscaling factor, the depth-to-space transformation reshapes the feature map to dimensions (H×r, W×r, C). Additionally, upscaling module 904 processes bottlenecked features 909 and downscaled features 908 through skip connections. Skip connections retain spatially detailed information from earlier layers, complementing the abstract high-level representations in bottlenecked features. In some examples, the combination is typically achieved through element-wise addition:

$${U}^{′} ( i , j ) = U ( i , j ) + D ( i , j ) \qquad ( Equation 22 )$$

where U′(i,j) represents the combined upscaled feature 910, and D(i,j) is the corresponding downscaled feature 908. Upscaling module 904 is described in more detail in conjunction with FIG. 9D.

Convolution layer 901B processes upscaled features 910 and generates processed convolution features 911. In various embodiments, convolution layer 901B extracts spatial features from upscaled features 910 by applying convolutional filters that scan across upscaled features 910 in a sliding window fashion. Each filter detects specific patterns such as edges, textures, or other visual structures associated with artifacts. The result of applying convolutional filters is a set of feature maps, referred to as processed convolution features 911, that highlight the presence of the patterns at different locations within upscaled features 910. For example, if an upscaled feature 910 contains a streak-like artifact, convolution layer 901B could generate a feature map where high-intensity values correspond to the locations of the streak. The convolution operation can be defined as described in Equation 18. In various embodiments, convolution layer 901B includes wide convolution layers, allowing for the capture of low-level patterns important for detecting pixel-level artifacts.

Sigmoid layer 905 processes one or more processed convolution features 911 and generates artifact detections 803. In various embodiments, sigmoid layer 905 applies a non-linear activation function to the processed convolution features 911, transforming convolution features 911 into a heatmap which includes probabilities that represent the likelihood of artifact presence at each pixel or region within the input processed video frame 802. The sigmoid activation function is mathematically expressed as:

$$S ( x ) = \frac{1}{1 + {e}^{- x}} \qquad ( Equation 23 )$$

where S(x) is the sigmoid output, representing the probability of an artifact, and x is the input feature value from the processed convolution features 911. The sigmoid function compresses the input values into a range between 0 and 1, with higher values indicating a higher confidence of artifact detection. In some embodiments, artifact detections 803 also include spatial information, such as bounding boxes or centroid coordinates, derived from the heatmap.

FIG. 9B is a more detailed illustration of the downscaling module 902 of the artifact detection model 559, according to various embodiments. Downscaling module 902 processes convolution features 907 and generates downscaled features 908. As shown, downscaling module 902 includes, without limitation, a max pooling convolution layer 912 and a convolution block 913A.

Max pooling convolution layer 912 applies a max pooling operation to the input convolution features 907, which reduces the spatial dimensions of the feature maps while preserving the most prominent features in each local region. The operation can be mathematically expressed by Equation 19. The pooled features from the max pooling convolution layer 912 are then passed as input to convolution block 913A.

Convolution block 913A applies further convolutional operations, extracting refined spatial and semantic features from the reduced spatial representation. In some embodiments, convolution block 913A includes one or more layers, such as convolutional units, group normalization modules, and activation functions (e.g., a sigmoid linear unit). In some embodiments, the output of the max pooling convolution layer 912 is added to the output of the convolution block 913A through an element-wise addition operation. The combination can be expressed as:

$$D ( i , j ) = P ( i , j ) + C ( i , j ) \qquad ( Equation 24 )$$

where D(i,j) represents the downscaled features 908, P(i,j) represents the pooled features, and C(i,j) represents the features extracted by convolution block 913A. Convolution block 913A is described in more detail in conjunction with FIG. 9E.

FIG. 9C is a more detailed illustration of bottleneck module 903 of artifact detection model 559, according to various embodiments. Bottleneck module 903 processes downscaled features 908 and generates bottlenecked features 909. As shown, bottleneck module 903 includes two convolution blocks, 913B and 913C, which sequentially refine and compress the input features while preserving information relevant to artifact detection. Convolution block 913B receives downscaled features 908 and applies one or more convolutional operations to extract and refine spatial and semantic features. The output of convolution block 913B is passed to convolution block 913C, which further processes the features using additional layers of convolutional operations. In some embodiments, convolution blocks 913B and 913C include one or more layers, such as convolutional units, group normalization modules, and activation functions (e.g., a sigmoid linear unit). The outputs of both convolution block 913B and convolution block 913C are combined through an element-wise addition operation, which ensures that the features extracted at each stage are aggregated. Mathematically, the bottlenecked features 909 can be expressed as B(i,j)=C_{913B}(i,j)+C_{913C}(i,j), where B(i,j) represents bottlenecked features 909, C_{913B}(i,j) is the output of convolution block 913B, and C_{913C}(i,j) is the output of convolution block 913C. Convolution blocks 913B and 913C are described in more detail in conjunction with FIG. 9E.

FIG. 9D is a more detailed illustration of upscaling module 904 of artifact detection model 559, according to various embodiments. Upscaling module 904 processes downscaled features 908 and bottlenecked features 909 to generate upscaled features 910. Upscaling module 904 is designed to recover spatial resolution and enhance the feature representation by incorporating information from both low-resolution feature maps included in downscaled features 908 and bottlenecked feature maps included in bottlenecked features 909. As shown, upscaling module 904 includes, without limitation, a depth-to-space transformation module 914 and two convolution blocks, 913D and 913E.

Depth-to-space transformation module 914 rearranges the feature channels into spatial dimensions, effectively increasing the spatial resolution of the feature map included in bottlenecked features 909 and downscaled features 908. For example, if the bottlenecked features 909 have dimensions (H, W, C×r²), where H and W are the spatial dimensions, C is the number of feature channels, and r is the upscaling factor, the depth-to-space transformation reshapes the feature map to dimensions (H×r, W×r, C). Depth-to-space transformation module 914 expands the spatial representation while maintaining consistency in the feature channel distribution. For example, if r=2, and the input dimensions are (64,64,16), the output dimensions after depth-to-space transformation would be (128,128,4), doubling the spatial resolution in both directions. After the transformation, the output is passed to convolution block 913D.

Convolution block 913D applies a series of convolutional operations. The operations include, without limitation, filtering to highlight significant spatial features, normalization to stabilize training and inference, and activation functions to introduce non-linearity for capturing patterns. The output of convolution block 913D is then passed to convolution block 913E, which further refines the features.

Convolution block 913E applies additional layers of convolution, normalization, and activation to enhance the spatial and semantic coherence of the upscaled features. In some embodiments, the outputs of convolution block 913D and convolution block 913E are combined using an element-wise addition operation. Mathematically, the upscaled features 910 U(i,j) are given by U(i,j)=C_{913D}(i,j)+C_{913E}(i,j), where C_{913D}(i,j) represents the output of convolution block 913D, and C_{913E}(i,j) represents the output of convolution block 913E.

FIG. 9E is a more detailed illustration of the convolution blocks 913A-913E, according to various embodiments. As shown, convolution blocks 913A-913E include, without limitation, a convolution unit 920, a group normalization module 921, and a sigmoid linear unit 922. Convolution blocks 913A-913E process one or more input features 923 and generate one or more output features 924. Input features 923 includes various intermediate representations of data processed by previous layers in artifact detection model 559. For example, in convolution block 913A included in downscaling module 902, input features 923 could include spatially reduced representations of convolution features 907, capturing both low-level edges and brightness variations. In convolution block 913D within upscaling module 904, input features 923 can include spatially enriched representations generated by depth-to-space transformation module 914, which incorporate detailed spatial and semantic information from bottlenecked features 909 and downscaled features 908. Output features 924 are processed representations of input features 923, with enhanced spatial and semantic characteristics useful for artifact detection. For example, in convolution block 913C within bottleneck module 903, output features 924 could represent high-level semantic patterns, such as streak-like artifacts or clustered noise regions, extracted from downscaled features 908. In convolution block 913E included in upscaling module 904, output features 924 can represent spatially enhanced feature maps that highlight subtle artifacts, such as hot pixels or small streaks, while preserving the spatial coherence and intensity.

Convolution unit 920 generates one or more convolution feature maps based on one or more input features 923. In various embodiments, convolution unit 920 performs one or more convolution operations on input features 923 to extract spatial patterns and features relevant for artifact detection. In some embodiments, convolution unit 920 applies a set of learnable filters (e.g., kernels) to input features 923, generating convolution feature maps that emphasize specific spatial structures, such as edges, textures, or artifact-like patterns. For example, in earlier layers of artifact detection model 559, convolution unit 920 included in convolution blocks 913A-913C could extract low-level features such as brightness variations, localized edges associated with pixel-level artifacts, and/or the like. In deeper layers, convolution unit 920 included in convolution blocks 913D and 913E could extract high level patterns, such as elongated streaks or clustered regions indicative of artifacts. In at least one embodiment, convolution unit 920 computes the convolution feature map for each filter by performing element-wise multiplications between the filter and patches of input features 923, followed by summation. Mathematically, the operation for a single filter can be expressed as:

$$F ( x , y ) = {\sum }_{i = - k}^{k} {\sum }_{j = - k}^{k} W ( i , j ) \cdot X ( x + i , y + j ) + b \qquad ( Equation 25 )$$

where F(x,y) is the value of the convolution feature map at position (x,y), W(i,j) represents the weights of the filter, X(x+i,y+j) denotes the corresponding values of input feature 923 in the receptive field of the filter, and b is a bias term. Here, k represents the kernel size, which determines the spatial extent of the convolution operation. In some embodiments, convolution unit 920 uses filters of varying sizes and strides to capture features at different scales and resolutions. For example, a smaller kernel size (e.g., 3×3) can focus on fine-grained details, such as hot pixels, while larger kernels (e.g., 7×7) capture broader patterns, such as motion blur or streak artifacts.

Group normalization module 921 processes convolution feature maps and generates one or more normalized features. In various embodiments, group normalization module 921 normalizes the convolution feature maps by mitigating internal covariate shift. Unlike batch normalization, which normalizes features across the batch dimension, group normalization operates independently of batch size by dividing the channels of a feature map into predefined groups and normalizing each group separately. For a feature map X with spatial dimensions (H,W) and C channels, group normalization module 921 computes the mean and variance for each group g as follows:

$${μ}_{g} = \frac{1}{\vert G \vert} {\sum }_{i ∈ G} {X}_{i} , {σ}_{g}^{2} = \frac{1}{\vert G \vert} {\sum }_{i ∈ G} {( {X}_{i} - {μ}_{g} )}^{2} \qquad ( Equation 26 )$$

where G represents the set of channels within group g, |G| is the number of elements in the group, Xᵢ represents the value of convolution feature map at a given position in the group, μ_{g} is the mean, and

$${σ}_{g}^{2}$$

is the variance. Each Xᵢ is then normalized using the computed mean and variance:

$${X}_{i}^{\hat{}} = \frac{{X}_{i} - {μ}_{g}}{\sqrt{{σ}_{g}^{2} + ϵ}} \qquad ( Equation 27 )$$

where ∈ is a small constant added for numerical stability. The normalized values are then scaled and shifted using learnable parameters γ_{g} and β_{g}:

$${Y}_{i} = {γ}_{g} {X}_{i}^{\hat{}} + {β}_{g} \qquad ( Equation 28 )$$

where Yᵢ is the output of the normalization operation.

SiLU 922 processes one or more normalized features and generates one or more output features 924. In some examples, SiLU 922 uses the SilU activation function defined as:

$$SiLU ( x ) = x \cdot S ( x ) \qquad ( Equation 29 )$$

where x represents the input feature value, and S(x) is the sigmoid function given by Equation 23. Unlike traditional activation functions, such as rectified linear units and/or the like, which abruptly clamp negative values to zero, SiLU 922 provides a smooth, continuous mapping that allows for small negative feature values. For example, when processing video frames, SiLU 922 can highlight faint pixel-level anomalies, such as hot pixels or streak artifacts, by preserving low-intensity signals that could otherwise be lost with harsher activation functions. Additionally, the smooth gradient of SiLU 922 helps stabilize training, reducing the risk of gradient vanishing or gradient exploding during optimization of the one or more parameters of artifact detection model 559.

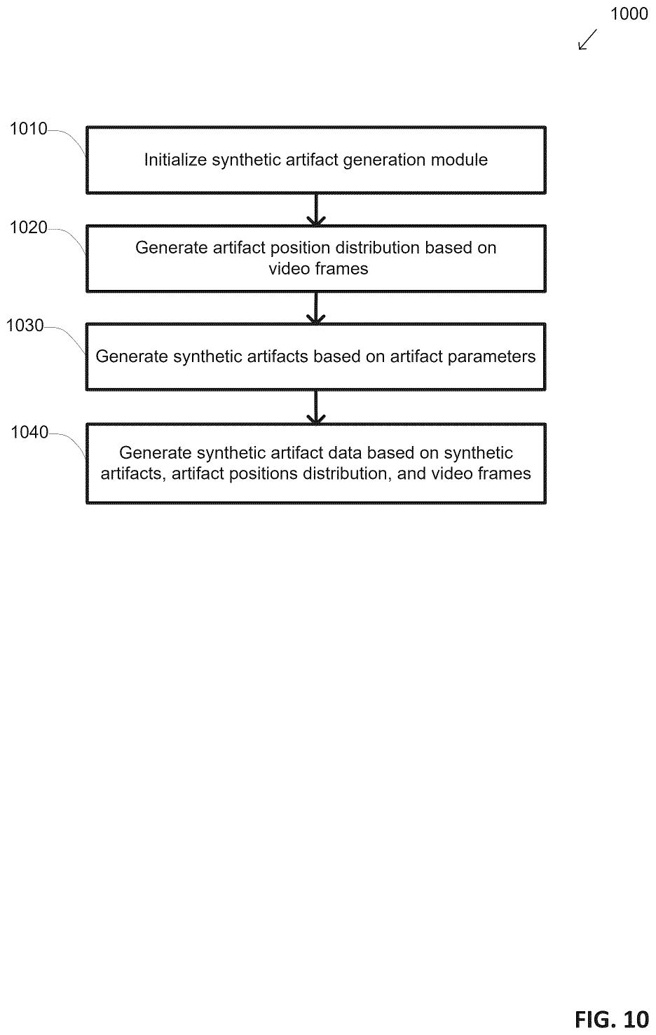

FIG. 10 sets forth a flow diagram of method steps for generating synthetic artifact data 560, according to various embodiments. Although the method steps are described in conjunction with the systems of FIGS. 1-6, persons skilled in the art will understand that any system configured to perform the method steps in any order falls within the scope of the present disclosure.

The method 1000 begins with step 1010, where synthetic artifact generation module 515 is initialized. In various embodiments, synthetic artifact generation module 515 initializes artifact parameters 601, which include type, shape, size, intensity, orientation, color, and/or the like, to define the specific characteristics of synthetic artifacts 605. For example, the type parameter is initialized to determine whether the synthetic artifact 605 is symmetrical, curvilinear, and/or the like. In some embodiments, synthetic artifact generation module 515 initializes the scales σ₁ and σ₂ of the Gaussian kernel for symmetrical artifacts as described in Equation 1, the orientation angle θ as given in Equation 2, and the base intensity I_{base}. For curvilinear artifacts, synthetic artifact generation module 515 initializes the line length L and direction vectors d for the random walk as described in Equation 3. Additionally, the Gaussian blur applied to curvilinear artifacts is initialized with parameters, such as kernel size and standard deviation (o) as described by Equation 4. Synthetic artifact generation module 515 also initializes parameters for generating the artifact position distribution 606. For edge values, parameters such as the Sobel filter kernel size and any smoothing factors are initialized to compute horizontal and vertical gradients as given in Equations 6 and 7. The small value e as described in Equation 8 is initialized. For motion values, synthetic artifact generation module 515 initializes various parameters, such as the temporal window size used to compute differences and normalization factors, as described in Equations 9 and 10. The proportion of curvilinear artifacts p_{curvilinear}, the dilation factor for refining the probability map, and the margin size for masking video frame 607 boundaries are also initialized. For artifact placement, synthetic artifact generation module 515 initializes artifact patch dimensions (wₐ,hₐ) as described in Equation15, ensuring synthetic artifacts 605 fit within the video frame 607 bounds. Furthermore, the noise map N as described in Equation 16, used to track artifact placements and intensities, is initialized (e.g., with zeros).

At step 1020, artifact position determination module 603 generates artifact position distribution 606 based on video frames 607. In various embodiments, artifact position determination module 603 uses various metrics calculated based on video frames 607, such as brightness values, edge values, movement values, and/or the like, to generate artifact position distribution 606. In some embodiments, artifact position determination module 603 calculates the brightness values in a sequence of steps to determine the average pixel intensity across the grayscale version of video frames 607. First, video frames 607 are converted from original color format (e.g., RGB) to grayscale, where each pixel is reduced to a single intensity value representing the luminance. For each pixel location across a plurality of frames, the intensity values are averaged along the temporal axis to generate a brightness map, such as using Equation 5. In at least one embodiment, artifact position determination module 603 calculates edge values by determining the magnitude of gradients in video frames 607. In some examples, to compute edge values, artifact position determination module 603 uses Sobel operators, which are applied to each video frame 607 to calculate intensity gradients in the horizontal and vertical directions, as described in Equation 6. The edge magnitude at each pixel is then computed as the Euclidean norm of the gradients in Equation 6, such as using Equation 7. The edge magnitude is normalized by dividing each value by the maximum gradient magnitude in video frame 607, such as using Equation 8. In some embodiments, artifact position determination module 603 calculates movement values by analyzing the temporal differences between consecutive grayscale video frames 607, capturing regions with significant pixel intensity changes over time, indicative of motion. In some examples, to compute movement values, artifact position determination module 603 first converts video frames 607 to grayscale. Temporal differences are then computed for each pixel location by subtracting the intensity of the corresponding pixel in the previous frame from the current frame using Equation 9. The temporal differences are aggregated across all frames to compute the motion map using the L1 norm using Equation 10. To ensure consistency and scale invariance, the movement values are normalized by dividing each value by the maximum motion value in the map plus a small value to avoid division by zero, as described in Equation 11. In various embodiments, artifact position determination module 603 generates artifact position distribution 606 based on brightness values, edge values, movement values, and/or the like, to create a sampling probability map that determines the likelihood of placing synthetic artifacts 605 at specific pixel locations in video frames 607. In some examples, in order to generate artifact position distribution 606, artifact position determination module 603, first generates a probability map by weighting the complement of each metric, such as movement values, edges values, and brightness values, to prioritize regions that are static, low-contrast, and dark. In some examples, the combined probability for a pixel at a location can be computed using Equation 12. Next, the probability map is processed to refine the distribution. A dilation operation is applied to expand high-probability regions, ensuring artifacts are not placed too close to dynamic, high contrast, or bright areas. Additionally, a boundary mask is applied to avoid placing artifacts near the edges of the frame, as near the edge areas introduce visual inconsistencies. Finally, the processed probability map is flattened and inverted to create a sampling distribution where lower values correspond to higher placement probabilities. The distribution is normalized to ensure that the probabilities sum to 1, forming a valid probability distribution for sampling artifact positions, as described by Equation 13. Artifact placement module 604 then generates artifact position distribution 606.

At step 1030, artifact generation module 602 generates synthetic artifacts 605 based on artifact parameters 601. In some embodiments, artifact generation module 602 generates symmetrical artifacts included in synthetic artifacts 605. In some embodiments, artifact generation module 602 generates symmetrical artifacts using anisotropic Gaussian distributions to replicate pixel anomalies that are symmetrical along at least one axis. For symmetrical artifacts, artifact generation module 602 uses artifact parameters 601, such as scale, orientation, hue, intensity, and/or asymmetry factors, as described in Equations 1 and 2. In at least one embodiment, artifact generation module 602 generates curvilinear artifacts included in synthetic artifacts 605. In various embodiments, artifact generation module 602 generates curvilinear artifacts using directional random walks. In various embodiments, artifact generation module 602 generates curvilinear artifacts by starting a random walk at the center of the video frame 607, and for each step: (i) chooses a direction randomly from predefined options (e.g., horizontal or vertical) and (ii) updates the position, as described by Equation 3. At each step, intensity is sampled randomly and applied to the pixel. The intensity is normalized and scaled to simulate realistic brightness variations. The resulting path is then smoothed using Gaussian blur to create a streak-like synthetic artifact 605, as described by Equation 4. In various embodiments, steps 1020 and 1030 are performed concurrently or sequentially.

At step 1040, artifact placement module 604 generates synthetic artifact data 560 based on synthetic artifacts 605, artifact positions distribution 606, and video frames 607. Using synthetic artifacts 605 generated by artifact generation module 602, artifact placement module 604 determines suitable locations for placing (e.g., superimposing) synthetic artifacts 605 within video frames 607 by sampling positions from the artifact position distribution 606. In various embodiments, for each synthetic artifact 605, artifact placement module 604 first determines artifact type, such as curvilinear artifacts and symmetrical artifacts, based on a predefined proportion. In some examples, if a random value r satisfies r<p_{curvilinear}, where p_{curvilinear} is the proportion of curvilinear artifacts, a curvilinear synthetic artifact 605 is selected; otherwise, a symmetrical artifact is selected. The intensity of the artifact is scaled randomly. Once the artifact type is determined, artifact placement module 604 samples a position for the synthetic artifact 605 from the artifact position distribution 606, which provides a probability map indicating preferred locations for artifact placement. The sampling process selects an index i from artifact position distribution 606 prob_{dist} as defined in Equation 13, and the corresponding spatial coordinates are derived using Equation 14. The sampled position is adjusted to center the synthetic artifact 605 within the target area by calculating the starting x and y coordinates as x_“start”=max(0,x−|−w_a/2) and

$${y}_{s t a r t} = max ( 0 , y - \frac{{h}_{a}}{2} ) ,$$

where wₐ and hₐ are the width and height of synthetic artifact 605. In various embodiments, artifact placement module 604 clips the starting coordinates to ensure that the artifact fits within the bounds of the frame. Once the position is determined, artifact placement module 604 superimposes synthetic artifact 605 onto the video frame 607 by blending the synthetic artifact 605 with the existing pixel values at the selected position. In some embodiments, for each pixel in the artifact patch, artifact placement module 604 computes the updated pixel value in the video frame 607 using Equation 15 ensuring that pixel values remain within the normalized range of 0 to 1. Whenever video frames 607 include a plurality of frames, synthetic artifact 605 is typically applied to the center frame of the sequence to maintain temporal consistency. Artifact placement module 604 also updates a noise map to track the placement and intensity of synthetic artifacts 605 using Equation 16. In various embodiments, artifact placement module 604 superimposes symmetrical artifacts on low-motion, dark regions of video frames 607 to mimic real-world conditions. In at least one embodiment, artifact placement module 604 aligns curvilinear artifacts with high-contrast edges or smooth gradients in video frames 607 to mimic real-world streaking artifacts observed in motion blur or lens scratches.

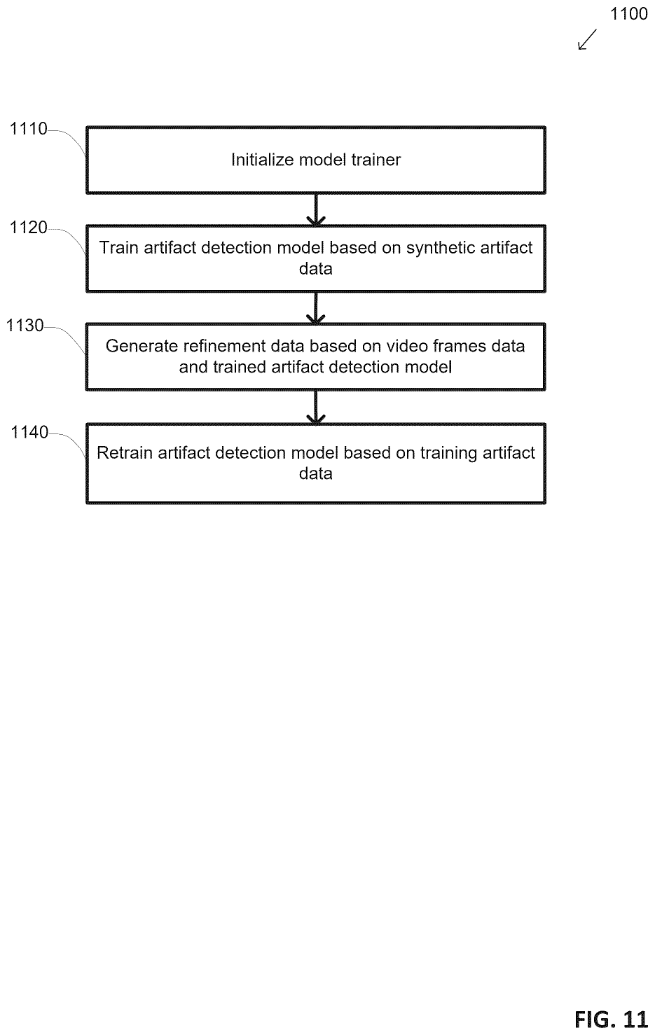

FIG. 11 sets forth a flow diagram of method steps for training artifact detection model 559, according to various embodiments. Although the method steps are described in conjunction with the systems of FIGS. 1-5, 7A-7C, and 9A-9E, persons skilled in the art will understand that any system configured to perform the method steps in any order falls within the scope of the present disclosure.

The method 1100 begins with step 1110, wherein model trainer 514 is initialized. In various embodiments, model trainer 514 initializes one or more parameters of artifact detection model 559, including the weights and biases of the convolutional layers, normalization layers, activation functions, and/or the like. In some embodiments, the one or more parameters are initialized using random distributions, such as Xavier initialization or He initialization, to ensure that the optimization process begins with a diverse parameter space. For example, convolutional weights can be sampled from a uniform or normal distribution scaled by the size of the input layer, while biases are often initialized to zero. Model trainer 514 also initializes hyperparameters used during training, such as learning rate, batch size, number of epochs, and optimizer configurations (e.g., momentum or weight decay for SGD or beta values for Adam optimizer). In some embodiments, model trainer 514 initializes one or more hyperparameters of EMA, such as initializing a the smoothing factor as defined in Equation 17. In some embodiments, model trainer 514 divides synthetic artifact data 560 and refinement data 561 into training and validation subsets. In some embodiments, model trainer 514 splits synthetic artifact data 560 and refinement data 561 into one or more batches for training.

At step 1120, model trainer 514 trains artifact detection model 559 based on synthetic artifact data 560. In various embodiments, data processing module 517 generates processed video frames 702 based on video frames 701 included in synthetic artifact data 560. In some embodiments, data processing module 517 resizes video 701 to match the input dimensions expected by artifact detection model 559. In various embodiments, data processing module 517 normalizes the pixel values in video frames 701 to a predefined range, such as 0 to 1 or −1 to 1, to standardize the input data and facilitate training or inference of artifact detection model 559. Additionally, data processing module 517 organizes video frames 701 into temporal sequences whenever artifact detection model 559 uses spatiotemporal features. In some embodiments, data processing module 517 also applies noise reduction techniques to remove irrelevant information and edge-enhancement filters to emphasize features important for artifact detection. Artifact detection model 559 generates one or more artifact detections 703 based on processed video frames 701. Loss calculation module 518 generates loss 705 based on ground truth artifacts 704 and artifact detections 703. In various embodiments, loss calculation module 518 generates loss 705 based on the difference between artifact detections 703 and the actual artifact annotations included in ground truth artifacts 704, guiding the optimization of artifact detection model 559 during training by model trainer 514. In some embodiments, loss calculation module 518 uses a combination of loss functions to improve the detection performance of artifact detection model 559. In some embodiments, loss calculation module 518 applies weighting to certain types of discrepancies between artifact detections 703 and ground truth artifacts 704, prioritizing specific error types for correction. Model trainer 514 updates one or more parameters of artifact detection model 559 based on loss 705. In various embodiments, model trainer 514 updates the one or more parameters of artifact detection model 559 by iteratively using optimization algorithms, such as SGD, Adam, and/or the like, to minimize loss 705. At each iteration, the gradients of loss 705 with respect to the parameters of artifact detection model 559 are computed, and the parameters are updated in the direction that reduces loss 705. In some embodiments, model trainer 514 uses the EMA for the weights of artifact detection model 559 during training, as described by Equation 17. In various embodiments, model trainer 514 employs one or more stopping criteria to determine when training should be terminated. In some embodiments, model trainer 514 stops training artifact detection model 559 when loss 705 reaches a predefined threshold, indicating sufficient detection accuracy, or when loss 705 plateaus across several consecutive iterations, signaling that further training yields diminishing improvements. Additionally, model trainer 514 stops training artifact detection model 559 after a fixed number of iterations or epochs, or when artifact detection model 559 achieves a target detection performance metric, such as precision, recall, Dice coefficient, and/or the like, on a validation dataset included in training artifact data 557.

At step 1130, refinement data selection module 516 generates refinement data 561 based on video frames data 558 and trained artifact detection model 559. In various embodiments, data processing module 517 generates one or more processed video frames 712 based one or more video frames 711 from video frames data 558. In some embodiments, data processing module 517 resizes video frames 711 to match the input dimensions expected by artifact detection model 559. In various embodiments, data processing module 517 normalizes the pixel values in video frames 711 to a predefined range, such as 0 to 1 or −1 to 1, to standardize the input data and facilitate the training or inference process of artifact detection model 559. Additionally, data processing module 517 organizes video frames 711 into temporal sequences whenever artifact detection model 559 uses spatiotemporal features. Furthermore, data processing module 517 applies noise reduction techniques to video frames 711 to remove irrelevant information that could interfere with artifact detection and applies edge-enhancement filters to emphasize features important for identifying anomalies. The trained artifact detection model 559 generates one or more artifact detections 713, including but not limited to false positives and false negatives, based on one or more processed video frames 712. Refinement data selection module 516 generates artifact labels 714 based on one or more artifact detections 713. In various embodiments, refinement data selection module 516 selects frames that have false positive labels included in one or more artifact detections 713 and generates corresponding artifact labels 714 using various approaches. In some embodiments, refinement data selection module 516 compares artifact detections 713 against a corpus of frames labeled with ground truth artifacts, automatically identifying discrepancies. In some embodiments, refinement data selection module 516 uses manual reviews where human operators examine artifact detections 713. In various embodiments, refinement data selection module 516 uses various automated approaches. One automated approach includes analyzing one or more confidence scores included in artifact detections 713, where artifact detections 713 with low confidence are flagged as potential false positives. Another automated approach uses ensemble-based consensus, comparing outputs from multiple artifact detection models to flag inconsistencies. Temporal or spatial consistency checks provide yet another automated approach, identifying artifact detections 713 that do not persist across consecutive frames or appear isolated in static regions. Once one or more artifact labels 714 are generated, refinement data selection module 516 stores one or more artifact labels 714 in refinement data 561, which includes annotations (e.g., artifact labels 714) for both true artifacts and false positives.

At step 1140, model trainer 514 retrains artifact detection model 559 based on training artifact data 557. In various embodiments, data processing module 517 generates one or more processed video frames 702 based on one or more video frames 701 from training artifact data 557, which includes video frames or images with artifact labels 714. Artifact detection model 559 generates artifact detections 703 based on processed video frames 702. Loss calculation module 518 generates loss 705 based on artifact detections 703 and ground truth artifacts 704 included in training artifact data 557. Model trainer 514 retrains artifact detection model 559 and updates one or more parameters of artifact detection model 559 based loss 705. In some embodiments, in iterative training processes, model trainer 514 uses staged optimization, alternating between training artifact detection model 559 using one or more batches of synthetic artifact data 560 and refinement data 561, repeating steps 1120-1140. During each iteration, model trainer 514 evaluates the precision and recall of artifact detection model 559 on previously unseen batches of synthetic artifact data 560 and refinement data 561. By identifying patterns in false positives and minimizing the occurrences of false positive artifact detections 703, model trainer 514 progressively improves artifact detection model 559. In various embodiments, model trainer 514 includes feedback from evaluating the precision and recall of artifact detection model 559, refining artifact detection model 559 to reduce loss 705. The parameters of artifact detection model 559 are iteratively updated, and the retraining process continues until predefined performance metrics, such as precision, recall, loss convergence, and/or the like, are achieved.

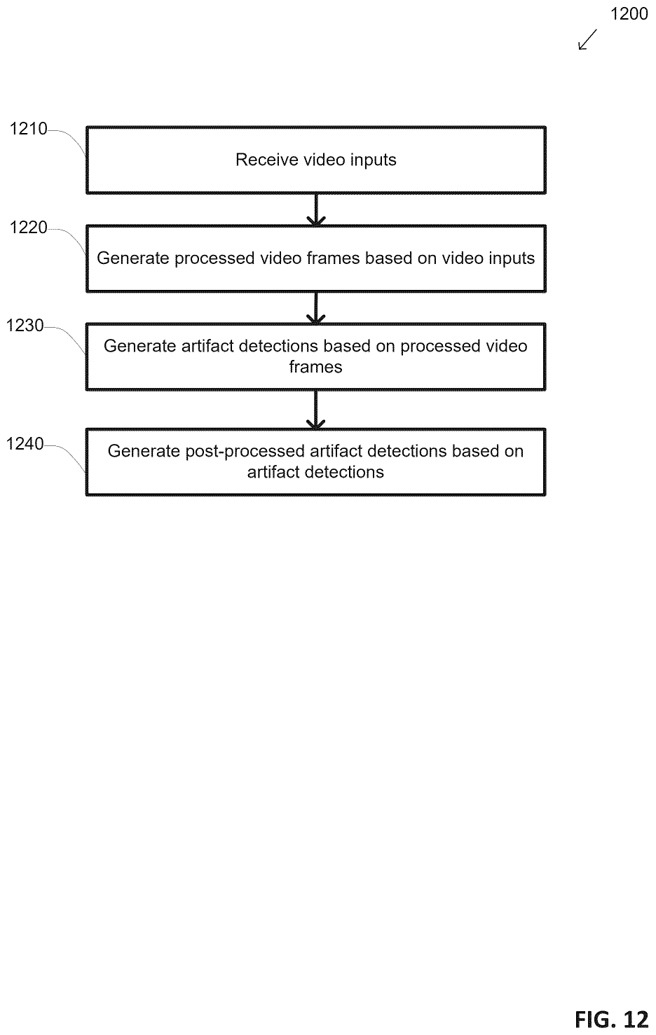

FIG. 12 sets forth a flow diagram of method steps for detecting artifacts, according to various embodiments. Although the method steps are described in conjunction with the systems of FIGS. 1-5 and 8-9E, persons skilled in the art will understand that any system configured to perform the method steps in any order falls within the scope of the present disclosure.

The method 1200 begins with step 1210, wherein artifact detection application 546 receives video inputs 801. In various embodiments, artifact detection application 546 receives one or more video inputs 801 via one or more I/O device(s), such as cameras, video files, streaming services, and/or the like. Video inputs 801 includes one or more video frames or images, such as raw video files, streaming data, image sequences, and/or the like.

At step 1220, input pre-processing module 547 generates processed video frames 802 based on video inputs 801. In various embodiments, input pre-processing module 547 processes video inputs 801 into individual video frames by extracting frames at predefined intervals or specific frame rates. Input pre-processing module 547 ensures the processed video frames 802 are appropriately formatted for subsequent analysis by artifact detection model 559 by performing various preprocessing operations. In some embodiments, input pre-processing module 547 resizes video frames included in video inputs 801 to match the input dimensions of artifact detection model 559. Input pre-processing module 547 also normalizes pixel values within a consistent range, such as 0 to 1, to standardize the data. In various embodiments, input pre-processing module 547 organizes video frames included in video inputs 801 into temporal sequences whenever artifact detection model 559 relies on spatiotemporal features for artifact detection. In some embodiments, input pre-processing module 547 performs optional preprocessing steps, such as edge enhancement or noise reduction, to emphasize features relevant to artifact detection.

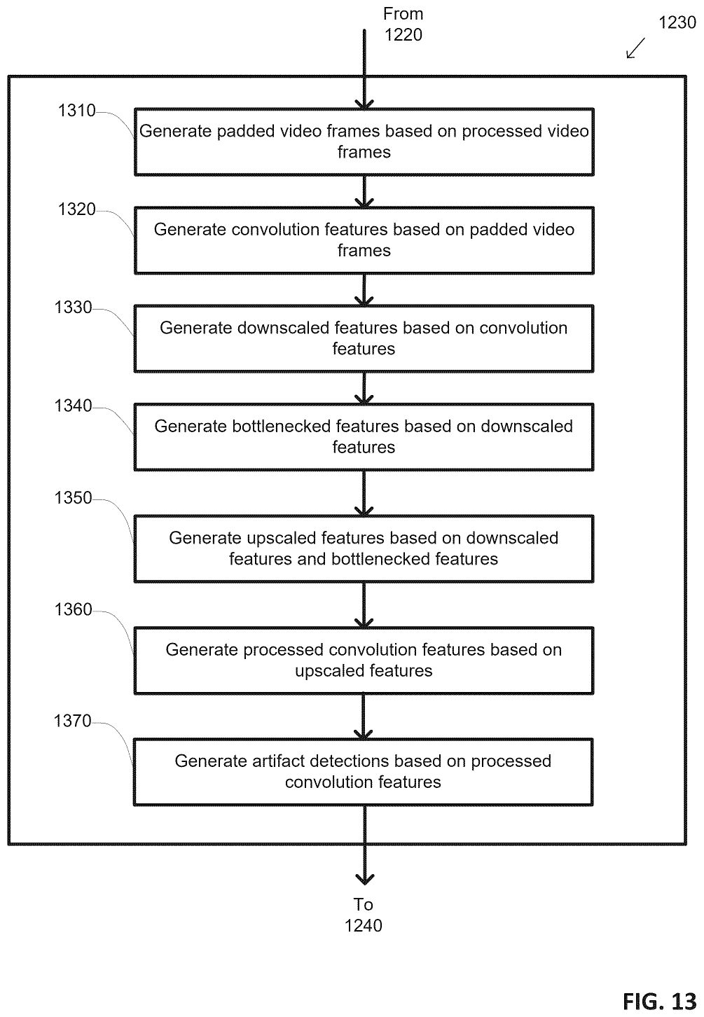

At step 1230, artifact detection application 546 generates artifact detections 803 based on processed video frames 802. In various embodiments, artifact detection application 546 uses the trained artifact detection model 559 to process one or more processed video frames 802 and generate artifact detections 803. Padding module 900 generates one or more padded video frames 906 based on one or more processed video frames 802. Convolution layer 901A generates one or more convolution features 907 based on one or more padded video frames 906. Downscaling module 902 generates one or more downscaled features 908 based on one or more convolution features 907. Bottleneck module 903 generates one or more bottlenecked features 909 based on one or more downscaled features 908. Upscaling module 904 generates one or more upscaled features 910 based on one or more downscaled features 908 and one or more bottlenecked features 909. Convolution layer 901B generates one or more processed convolution features 911 based on one or more upscaled features 910. Sigmoid layer 905 generates one or more artifact detections 803 based on one or more processed convolution features 911. Step 1230 is described in more detail in conjunction with FIG. 13.

At step 1240, artifact detection application 546 post-processes artifact detections 803. In various embodiments, artifact detection application 546 performs post-processing operations to refine and format the artifact detections 803 for further analysis or visualization. The post-processing operations include but are not limited to generating heatmaps, where each pixel's intensity reflects the confidence of artifact detection model 559 regarding the presence of an artifact. In some embodiments, artifact detection application 546 binarizes the heatmaps using a predefined confidence threshold to separate artifact regions from non-artifact regions, resulting in binary masks that indicate the presence or absence of artifacts. In at least one embodiment, after binarization, artifact detection application 546 applies connected component labeling to group contiguous artifact pixels into discrete labeled regions, enabling the identification of distinct artifact clusters within the processed video frames 802. In various embodiments, artifact detection application 546 calculates the centroids of the labeled regions, providing (x,y) coordinates for each detected artifact. In various embodiments, artifact detection application 546 provides various interfaces for displaying or accessing artifact detections 803. In some embodiments, artifact detection application 546 delivers various artifact detections 803 as structured output via a Docker container for integration with automated workflows. Alternatively, artifact detection application 546 uses a command-line interface to generate JSON output, allowing artifact detections 803 to be easily parsed. In at least one embodiment, artifact detection application 546 provides a graphical display of artifact detections 803 through a visual user interface, enabling users to view artifact locations overlaid on video frames for inspection.

FIG. 13 sets forth a flow diagram of method steps for detecting artifacts based on processed video frames 802 at step 1230 of method 1200, according to various embodiments. Although the method steps are described in conjunction with the systems of FIGS. 1-5 and 8-9E, persons skilled in the art will understand that any system configured to perform the method steps in any order falls within the scope of the present disclosure.

As shown at step 1310, padding module 900 generate padded video frames 906 based on processed video frames 802. In various embodiments, padding module 900 processes a plurality of processed video frames 802 at a time flattened across a channel dimension. In various embodiments, padding module 900 ensures that the dimensions of the processed video frames 802 are compatible with the input requirements of artifact detection model 559. In some examples, padding module 900 adds additional rows and/or columns of pixels around the frame to bring the dimensions to the nearest compatible size, such as setting pixel values to zero or a constant value. In at least one embodiment, padding module 900 applies padding symmetrically around the edges of processed video frames 802 to preserve the central features while ensuring padded video frame 906 align correctly with the architecture of artifact detection model 559.

At step 1320, convolution layer 901A generates convolution features 907 based on padded video frames 906. In various embodiments, convolution layer 901A extracts spatial features from padded video frames 906 by applying convolutional filters that scan across padded video frames 906 in a sliding window fashion generating convolution features 907, such as described in Equation 18. In various embodiments, convolution layer 901A includes wide convolution layers, allowing for the capture of low-level patterns important for detecting pixel-level artifacts.

At step 1330, downscaling module 902 generates downscaled features 908 based on convolution features 907. In various embodiments, downscaling module 902 reduces the spatial dimensions of convolution features 907 while retaining the most significant information, enabling artifact detection model 559 to focus on high-level patterns and reduce computational complexity. In various embodiments, downscaling module 902 divides each feature map included in one or more convolution features 907 into nonoverlapping regions and retains only the maximum value from each region using max pooling convolution layer 912, as described in Equation 19. In some embodiments, downscaling module 902 reduces the size of the feature maps included in convolution features 907. In some embodiments, downscaling module 902 uses extremum pooling, which retains both the maximum and minimum values within a region, emphasizing regions with both strong positive and negative feature intensities. The pooled features from the max pooling convolution layer 912 are then passed as input to convolution block 913A. Convolution unit 920 included in convolution block 913A generates one or more convolution feature maps based on one or more pooled features. In various embodiments, convolution unit 920 performs one or more convolution operations on the pooled features to extract spatial patterns and features relevant for artifact detection. In some embodiments, convolution unit 920 applies a set of learnable filters (e.g., kernels) to the pooled features, generating convolution feature maps that emphasize specific spatial structures, such as edges, textures, or artifact-like patterns. In at least one embodiment, convolution unit 920 computes the convolution feature map for each filter by performing element-wise multiplications between the filter and patches of the pooled features, followed by summation as described by Equation 25. In some embodiments, convolution unit 920 uses filters of varying sizes and strides to capture features at different scales and resolutions. Group normalization module 921 processes convolution feature maps and generates one or more normalized features. In various embodiments, group normalization module 921 normalizes the convolution feature maps by mitigating internal covariate shift. In some embodiments, group normalization module 921 computes the mean and variance for each group of channels as described by Equation 26, which are then normalized using the computed mean and variance as described by Equation 27. The normalized values are then scaled and shifted as described by Equation 28. SiLU 922 processes one or more normalized features and generates the output of the convolution block 913A as described by Equation 29. In some embodiments, the output of the max pooling convolution layer 912 is added to the output of the convolution block 913A through an element-wise addition operation, as described by Equation 24, generating downscaled features 908.

At step 1340, bottleneck module 903 generates bottlenecked features 909 based on downscaled features 908. In various embodiments, bottleneck module 903 reduces the number of feature channels in downscaled features 908 while retaining the most salient and high-level features for artifact detection. In various embodiments, bottleneck module 903 compresses downscaled features 908, reducing redundancy and computational complexity in subsequent layers of artifact detection model 559. In some embodiments, bottleneck module 903 employs convolutional operations with a smaller number of filters to achieve dimensionality reduction. In various embodiments, bottleneck module 903 includes two convolution blocks, 913B and 913C, which sequentially refine and compress the input features while preserving information relevant to artifact detection. Convolution block 913B receives downscaled features 908 and applies one or more convolutional operations to extract and refine spatial and semantic features. Convolution unit 920 included in convolution block 913B generates one or more convolution feature maps based on one or more downscaled features 908. In various embodiments, convolution unit 920 performs one or more convolution operations on the one or more downscaled features 908 to extract spatial patterns and features relevant for artifact detection. In some embodiments, convolution unit 920 applies a set of learnable filters (e.g., kernels) to the downscaled features 908, generating convolution feature maps that emphasize specific spatial structures, such as edges, textures, or artifact-like patterns. In at least one embodiment, convolution unit 920 computes the convolution feature map for each filter by performing element-wise multiplications between the filter and patches of the downscaled features 908, followed by summation as described by Equation 25. In some embodiments, convolution unit 920 uses filters of varying sizes and strides to capture features at different scales and resolutions. Group normalization module 921 processes convolution feature maps and generates one or more normalized features. In various embodiments, group normalization module 921 normalizes the convolution feature maps by mitigating internal covariate shift. In some embodiments, group normalization module 921 computes the mean and variance for each group of channels as described by Equation 26 and then normalized using the computed mean and variance as described by Equation 27. The normalized values are then scaled and shifted as described by Equation 28. SiLU 922 processes one or more normalized features and generates the output of the convolution block 913A as described by Equation 29. Similar to convolution block 913B, convolution block 913C processes the outputs of convolution block 913B and generates the outputs of convolution block 913C. The outputs of both convolution block 913B and convolution block 913C are combined through an element-wise addition operation generating bottlenecked features 909.

At step 1350, upscaling module 904 generates upscaled features 910 based on downscaled features 908 and bottlenecked features 909. In various embodiments, upscaling module 904 employs various techniques to generate upscaled features 910 and reconstruct spatial resolution, including nearest-neighbor interpolation as described in Equation 21, bilinear interpolation, transposed convolutions, depth-to-space transformation, and/or the like. In various embodiments, depth-to-space transformation module 914 included in upscaling module 904 rearranges the feature channels into spatial dimensions, effectively increasing the spatial resolution of the feature map included in bottlenecked features 909 and downscaled features 908. Depth-to-space transformation module 914 expands the spatial representation while maintaining consistency in the feature channel distribution. After the transformation, the output is passed to convolution block 913D. Convolution unit 920 included in convolution block 913D generates one or more convolution feature maps based on one or more outputs of the depth-to-space transformation module 914. In various embodiments, convolution unit 920 performs one or more convolution operations on the one or more outputs of depth-to-space transformation module 914 to extract spatial patterns and features relevant for artifact detection. In some embodiments, convolution unit 920 applies a set of learnable filters (e.g., kernels) to the one or more outputs of depth-to-space transformation module 914, generating convolution feature maps that emphasize specific spatial structures, such as edges, textures, or artifact-like patterns. In at least one embodiment, convolution unit 920 computes the convolution feature map for each filter by performing element-wise multiplications between the filter and patches of the outputs of depth-to-space transformation module 914, followed by summation as described by Equation 25. In some embodiments, convolution unit 920 uses filters of varying sizes and strides to capture features at different scales and resolutions. Group normalization module 921 processes convolution feature maps and generates one or more normalized features. In various embodiments, group normalization module 921 normalizes the convolution feature maps by mitigating internal covariate shift. In some embodiments, group normalization module 921 computes the mean and variance for each group of channels as described by Equation 26, which are then normalized using the computed mean and variance as described by Equation 27. The normalized values are scaled and shifted as described by Equation 28. SiLU 922 processes one or more normalized features and generates the output of the convolution block 913D as described by Equation 29. Similar to convolution block 913D, the outputs of convolution block 913D are processed convolution block 913E. In some embodiments, the outputs of convolution block 913D and convolution block 913E are combined using an element-wise addition operation generating upscaled features 910.

At step 1360, convolution layer 901B generates processed convolution features 911 based on upscaled features 910. In various embodiments, convolution layer 901B extracts spatial features from upscaled features 910 by applying convolutional filters that scan across upscaled features 910 in a sliding window fashion. Each filter detects specific patterns such as edges, textures, or other visual structures associated with artifacts generating processed convolution features 911, for example, using the convolution operation as described in Equation 18. In various embodiments, convolution layer 901B includes wide convolution layers, allowing for the capture of low-level patterns important for detecting pixel-level artifacts.

At step 1370, sigmoid layer 905 generates artifact detections 803 based on processed convolution features 911. In various embodiments, sigmoid layer 905 applies a non-linear activation function, as described in Equation 23, to the processed convolution features 911, transforming convolution features 911 into a heatmap which includes probabilities that represent the likelihood of artifact presence at each pixel or region within the input processed video frame 802. The sigmoid function compresses the input values into a range between 0 and 1, with higher values indicating a higher confidence of artifact detection.

In sum, the disclosed techniques include a synthetic artifact data generation module which processes one or more video frames and generates synthetic artifact data. In various embodiments, artifact position distribution is determined based on one or more video frames from video frames data. In at least one embodiment, one or more brightness values, edge values, and movement values are calculated based on one or more video frames. Based on one or more brightness values, edge values, and movement values, an artifact position distribution is generated. Concurrently or sequentially, one or more synthetic artifacts are generated, such as symmetrical artifacts and curvilinear artifacts, based on one or more artifact parameters. Then, synthetic artifact data is generated by superimposing one or more synthetic artifacts onto one or more video frames based on the artifact position distribution. The synthetic artifact data can then be used for training an artifact detection model.

The disclosed techniques also include an artifact detection model, which processes one or more video inputs and detects one or more visual artifacts in images. In various embodiments, one or more processed video frames are padded and then processed by a convolution layer generating one or more convolution features. The convolution features are then downscaled by a downscaling module and processed by a bottleneck module generating one or more bottlenecked features. The bottlenecked features are upscaled along with one or more downscaled features generated by the downscaling module to generate upscaled features. The upscaled features are processed by a convolution layer generating one or more processed convolution features. The one or more convolution features are processed by a sigmoid layer to detect the one or more visual artifacts.

The disclosed techniques further include training the artifact detection model based on the synthetic artifact data and refinement data, which includes training data that results in one or more false positives. The training process begins by the artifact detection model processing one or more video frames with artifacts from synthetic artifact data and generating artifact detections. A loss is calculated based on artifact detections and ground truth artifacts from synthetic artifact data. The loss is used to update one or more parameters of the artifact detection model. Once artifact detection model is trained, the trained artifact detection model is used to detect artifacts on one or more video frames. The artifact detections are used to determine the refinement data, which includes training examples that resulted in one or more false positive determinations by the artifact detection model. Finally, artifact detection model is re-trained using both the synthetic artifact data and the refinement data, where a loss is calculated based on artifact detections and ground truth artifacts and used to update the one or more parameters of artifact detection model.

At least one technical advantage of the disclosed techniques relative to prior art is that the disclosed techniques automate the detection of artifacts in video and image data, reducing the reliance on manual inspection. Unlike conventional approaches that depend on QC operators or technicians to visually inspect data, the disclosed techniques use a trained machine learning model capable of detecting pixel-level artifacts, such as hot pixels, compression errors, and/or the like. Another technical advantage of the disclosed techniques is that the disclosed techniques are scalable, enabling artifact detection in exponentially growing video and/or image datasets without increasing processing time or introducing delays. These technical advantages represent one or more technological improvements over prior art approaches.
1. In some embodiments, a computer-implemented method for generating one or more artifact detections comprises generating, based on one or more video inputs, one or more downscaled features using a first convolution block, generating, based on the one or more downscaled features, one or more bottlenecked features using a second convolution block and a third convolution block, generating, based on the one or more downscaled features and the one or more bottlenecked features, one or more upscaled features using a fourth convolution block and a fifth convolution block, and generating, based on the one or more upscaled features, the one or more artifact detections.
2. The computer-implemented method of clause 1, wherein generating the one or more downscaled features comprises generating, based on one or more convolution features, one or more pooled features, and generating, based on the one or more pooled features, one or more first features using the first convolution block, and generating, based on the one or more pooled features and the one or more first features, the one or more downscaled features.
3. The computer-implemented method of clauses 1 or 2, wherein generating the one or more bottlenecked features comprises generating, based on the one or more downscaled features, one or more first features using the second convolution block, generating, based on the one or more first features, one or more second features using the third convolution block, and generating, based on the one or more first features and the one or more second features, the one or more bottlenecked features.
4. The computer-implemented method of any of clauses 1-3, wherein generating the one or more upscaling features comprises generating, based on the one or more downscaled features and the one or more bottlenecked features, one or more first features, generating, based on the one or more first features, one or more second features using the fourth convolution block, generating, based on the one or more second features, one or more third features using the fifth convolution block, and generating, based on the one or more third features and the one or more third features, the one or more upscaling features.
5. The computer-implemented method of any of clauses 1-4, wherein generating the one or more first features comprises performing a depth-to-space transformation.
6. The computer-implemented method of any of clauses 1-5, wherein generating the one or more upscaled features comprises using nearest-neighbor interpolation.
7. The computer-implemented method of any of clauses 1-6, wherein generating the one or more artifact detections comprises applying a sigmoid activation function.
8. The computer-implemented method of any of clauses 1-7, wherein generating the one or more upscaled features comprises applying one or more skip connections.
9. The computer-implemented method of any of clauses 1-8, further comprising pre-processing the one or more video inputs by organizing a plurality of video frames included in the one or more video inputs into temporal sequences.
10. The computer-implemented method of any of clauses 1-9, further comprising padding the one or more video inputs.
11. The computer-implemented method of any of clauses 1-10, further comprising generating, based on the one or more artifact detections, one or more heatmaps.
12. In some embodiments, one or more non-transitory computer-readable media store instructions that, when executed by one or more processors, cause the one or more processors to perform a method comprising generating, based on one or more video inputs, one or more downscaled features using a first convolution block, generating, based on the one or more downscaled features, one or more bottlenecked features using a second convolution block and a third convolution block, generating, based on the one or more downscaled features and the one or more bottlenecked features, one or more upscaled features using a fourth convolution block and a fifth convolution block, and generating, based on the one or more upscaled features, one or more artifact detections.
13. The one or more non-transitory computer readable media of clause 12, wherein generating the one or more upscaled features comprises using nearest-neighbor interpolation.
14. The one or more non-transitory computer readable media of clauses 12 or 13, further comprising pre-processing the one or more video inputs by organizing a plurality of video frames included in the one or more video inputs into temporal sequences.
15. The one or more non-transitory computer readable media of any of clauses 12-14, further comprising generating, based on the one or more artifact detections, one or more heatmaps.
16. The one or more non-transitory computer readable media of any of clauses 12-15, further comprising, generating, based on the one or more heatmaps, one or more binarized heatmaps using a predefined confidence threshold, generating, based on the one or more binarized heatmaps, one or more labeled regions using connected component labeling, and calculating, based on the one or more labeled regions, one or more centroids.
17. The one or more non-transitory computer readable media of any of clauses 12-16, wherein each of the first convolution block, the second convolution block, the third convolution block, the fourth convolution block, and the fifth convolution block comprises a respective convolution unit, a respective group normalization module, and a respective sigmoid linear unit.
18. In some embodiments, a system comprises one or more memories storing instructions, and one or more processors that are coupled to the one or more memories and, when executing the instructions, are configured to generate, based on one or more video inputs, one or more downscaled features using a first convolution block, generate, based on the one or more downscaled features, one or more bottlenecked features using a second convolution block and a third convolution block, generate, based on the one or more downscaled features and the one or more bottlenecked features, one or more upscaled features using a fourth convolution block and a fifth convolution block, and generate, based on the one or more upscaled features, one or more artifact detections.
19. The system of clause 18, wherein each of the first convolution block, the second convolution block, the third convolution block, the fourth convolution block, and the fifth convolution block comprises a respective convolution unit, a respective group normalization module, and a respective sigmoid linear unit.
20. The system of clauses 18 or 19, wherein the respective group normalization module normalizes one or more features by mitigating internal covariate shift.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating one or more artifact detections, the method comprising:
generating, based on one or more video inputs, one or more downscaled features using a first convolution block;
generating, based on the one or more downscaled features, one or more bottlenecked features using a second convolution block and a third convolution block;
generating, based on the one or more downscaled features and the one or more bottlenecked features, one or more upscaled features using a fourth convolution block and a fifth convolution block; and
generating, based on the one or more upscaled features, the one or more artifact detections.

2. The computer-implemented method of claim 1, wherein generating the one or more downscaled features comprises:
generating, based on one or more convolution features, one or more pooled features; and
generating, based on the one or more pooled features, one or more first features using the first convolution block; and
generating, based on the one or more pooled features and the one or more first features, the one or more downscaled features.

3. The computer-implemented method of claim 1, wherein generating the one or more bottlenecked features comprises:
generating, based on the one or more downscaled features, one or more first features using the second convolution block;
generating, based on the one or more first features, one or more second features using the third convolution block; and
generating, based on the one or more first features and the one or more second features, the one or more bottlenecked features.

4. The computer-implemented method of claim 1, wherein generating the one or more upscaling features comprises:
generating, based on the one or more downscaled features and the one or more bottlenecked features, one or more first features;
generating, based on the one or more first features, one or more second features using the fourth convolution block;
generating, based on the one or more second features, one or more third features using the fifth convolution block; and
generating, based on the one or more third features and the one or more third features, the one or more upscaling features.

5. The computer-implemented method of claim 4, wherein generating the one or more first features comprises performing a depth-to-space transformation.

6. The computer-implemented method of claim 1, wherein generating the one or more upscaled features comprises using nearest-neighbor interpolation.

7. The computer-implemented method of claim 1, wherein generating the one or more artifact detections comprises applying a sigmoid activation function.

8. The computer-implemented method of claim 1, wherein generating the one or more upscaled features comprises applying one or more skip connections.

9. The computer-implemented method of claim 1, further comprising pre-processing the one or more video inputs by organizing a plurality of video frames included in the one or more video inputs into temporal sequences.

10. The computer-implemented method of claim 1, further comprising padding the one or more video inputs.

11. The computer-implemented method of claim 1, further comprising generating, based on the one or more artifact detections, one or more heatmaps.

12. One or more non-transitory computer-readable media storing instructions that, when executed by one or more processors, cause the one or more processors to perform a method comprising:
generating, based on one or more video inputs, one or more downscaled features using a first convolution block;
generating, based on the one or more downscaled features, one or more bottlenecked features using a second convolution block and a third convolution block;
generating, based on the one or more downscaled features and the one or more bottlenecked features, one or more upscaled features using a fourth convolution block and a fifth convolution block; and
generating, based on the one or more upscaled features, one or more artifact detections.

13. The one or more non-transitory computer readable media of claim 12, wherein generating the one or more upscaled features comprises using nearest-neighbor interpolation.

14. The one or more non-transitory computer readable media of claim 12, further comprising pre-processing the one or more video inputs by organizing a plurality of video frames included in the one or more video inputs into temporal sequences.

15. The one or more non-transitory computer readable media of claim 12, further comprising generating, based on the one or more artifact detections, one or more heatmaps.

16. The one or more non-transitory computer readable media of claim 15, further comprising;
generating, based on the one or more heatmaps, one or more binarized heatmaps using a predefined confidence threshold;
generating, based on the one or more binarized heatmaps, one or more labeled regions using connected component labeling; and
calculating, based on the one or more labeled regions, one or more centroids.

17. The one or more non-transitory computer readable media of claim 12, wherein each of the first convolution block, the second convolution block, the third convolution block, the fourth convolution block, and the fifth convolution block comprises:
a respective convolution unit;
a respective group normalization module; and
a respective sigmoid linear unit.

18. A system, comprising:
one or more memories storing instructions; and
one or more processors that are coupled to the one or more memories and, when executing the instructions, are configured to:
generate, based on one or more video inputs, one or more downscaled features using a first convolution block;
generate, based on the one or more downscaled features, one or more bottlenecked features using a second convolution block and a third convolution block;
generate, based on the one or more downscaled features and the one or more bottlenecked features, one or more upscaled features using a fourth convolution block and a fifth convolution block; and
generate, based on the one or more upscaled features, one or more artifact detections.

19. The system of claim 18, wherein each of the first convolution block, the second convolution block, the third convolution block, the fourth convolution block, and the fifth convolution block comprises:
a respective convolution unit;
a respective group normalization module; and
a respective sigmoid linear unit.

20. The system of claim 19, wherein the respective group normalization module normalizes one or more features by mitigating internal covariate shift.
